(19) United States
(12) Patent Application Publication
(10) Pub. No.: US 2026/0351939 A1
(43) Pub. Date: Nov. 5, 2026

(54) HINGE FOR ELECTRICAL BOX COVER

(71) Applicant: Hubbell Incorporated, Shelton, CT (US)

(72) Inventors: Stephen Michael Boener, Goshen, IN (US); Krishna C. Patel, Granger, IN (US)

(21) Appl. No.: 19/668,072

(22) Filed: May 5, 2026

Related U.S. Application Data
(60) Provisional application No. 63/800,026, filed on May 5, 2025.

(51) Int. Cl. H02G 3/14; H02G 3/08

(52) U.S. Cl. CPC H02G 3/14; H02G 3/081; H02G 3/088

(57) ABSTRACT

An in-use cover for an electrical device includes a base and a lid pivotably connected to the base. The base has an internal volume and includes a projection with a first asymmetrical shape extending from an outer surface. The first asymmetrical shape includes a first curved region and a first protruding region that extends from the first curved region. The lid is movable between an open position that at least partially exposes the electrical device and a closed position that encloses the electrical device in the internal volume. The lid includes an opening with a second asymmetrical shape. The second asymmetrical shape includes a second curved region and a second protruding region that extends from the second curved region. The projection is received within the opening. The first protruding region is selectively positionable within the second protruding region to limit rotation of the lid relative to the base.

### FIELD

This claims the benefit of U.S. 63/800,026, filed May 5, 2025, the contents of which is incorporated herein by reference in its entirety.

### FIELD

The present disclosure relates to a cover. More particularly, the present disclosure relates to a while-in-use cover.

### BACKGROUND

While-in-use covers may be used to cover and/or protect electrical devices, like electrical outlets. Particularly, while-in-use covers may be used with outdoor electrical receptacles to help limit liquid (e.g., precipitation, condensation, etc.) from reaching the electrical device (e.g., and damaging the circuitry).

### SUMMARY

Various examples of the present disclosure can overcome various of the aforementioned and other disadvantages associated with known terminal connectors and offer new advantages as well.

In some forms, an in-use cover for an electrical device includes a base and a lid pivotably connected to the base.

In some forms, an in-use cover for an electrical device includes a base and a lid pivotably connected to the base. The base has an internal volume and includes a projection with a first asymmetrical shape extending from an outer surface. The first asymmetrical shape includes a first curved region and a first protruding region that extends from the first curved region. The lid is movable between an open position that at least partially exposes the electrical device and a closed position that encloses the electrical device in the internal volume. The lid includes an opening with a second asymmetrical shape. The second asymmetrical shape includes a second curved region and a second protruding region that extends from the second curved region. The projection is received within the opening. The first protruding region is selectively positionable within the second protruding region to limit rotation of the lid relative to the base.

In some forms, an in-use cover for an electrical device includes a base and a lid pivotably connected to the base. The base has an internal volume and includes an opening having a first asymmetrical shape extending from an outer surface. The first asymmetrical shape includes a first curved region and a first protruding region that extends from the first curved region. The lid is movable between an open position that at least partially exposes the electrical device and a closed position that encloses the electrical device in the internal volume. The lid includes a projection with a second asymmetrical shape. The second asymmetrical shape includes a second curved region and a second protruding region that extends from the second curved region. The projection is received within the opening. The first protruding region is selectively positionable within the second protruding region to limit rotation of the lid relative to the base.

In some forms, an in-use cover for an electrical device includes a base and a lid connected to the base. The base has an internal volume and includes a projection having a first asymmetrical shape extending from an outer surface. The first asymmetrical shape includes a first curved region and a first protruding region that extends from the first curved region. The lid includes an opening having a second asymmetrical shape. The second asymmetrical shape includes a second curved region and a second protruding region that extends from the second curved region. The first protruding region is disposed within the second protruding region in a latched position to limit rotation of the lid relative to the base. The lid is translatable relative to the base between the latched position and an unlatched position. The opening can move relative to the projection so that the first protruding region is spaced apart from the second protruding region. The lid is rotatable relative to the base between the unlatched position and an opened position where the internal volume is at least partially accessible.

In some forms, an in-use cover for an electrical device includes a base with an internal volume and a lid connected to the base. The base includes a projection with a first asymmetrical shape that extends from an outer surface. The first asymmetrical shape includes a first curved region and a first protruding region that extends from the first curved region. The base also includes a channel disposed proximate to the projection. The channel includes a first channel portion and a second channel portion. The lid includes an opening with a second asymmetrical shape. The second asymmetrical shape includes a second curved region and a second protruding region that extends from the second curved region. The lid also includes a pin disposed proximate to the opening on an inner surface of the lid. The projection is received within the opening. The pin extends through the channel. The first protruding region is selectively positionable within the second protruding region to limit rotation of the lid relative to the base.

In some forms, an in-use cover for an electrical device includes a base with an internal volume and a lid connected to the base. The base includes a first projection that extends from an outer surface. The first projection has a rounded shape. The base also includes a second projection that extends from the outer surface and is spaced apart from the first projection. The second projection has an elongated shape. The lid includes an opening with an elongated shape and a channel disposed proximate to the opening. The channel includes a first channel portion and a second channel portion. The first projection is received within the opening. The second projection extends through the channel.

In some forms, an in-use cover for an electrical device includes a base with an internal volume and a lid connected to the base. The base includes a first projection with a first asymmetrical shape that extends from an outer surface. The first asymmetrical shape includes a first curved region and a first protruding region that extends from the first curved region. The first projection is disposed proximate a first end of the base. The base also includes a second projection that extends from the outer surface. The second projection is disposed proximate a second end of the base spaced apart from the first projection. The second projection has an elongated shape. The lid includes an opening with a second asymmetrical shape. The second asymmetrical shape includes a second curved region and a second protruding region that extends from the second curved region. The opening is disposed proximate a first end of the lid. The lid also includes a groove having an undercut disposed proximate to a second end of the lid. The first projection is received within the opening. The second projection is received within the groove. The first protruding region is selectively positionable within the second protruding region to limit rotation of the lid relative to the base.

In some forms, an in-use cover for an electrical device includes a base with an internal volume and a lid connected to the base. The base includes a first connecting region that has a first opening with a first asymmetrical shape that extends from an outer surface of the base. The first asymmetrical shape includes a first curved region and a first protruding region that extends from the first curved region. The first opening is disposed on a first edge of the base. The base also includes a second connecting region that has a second opening with the first asymmetrical shape that extends from the outer surface of the base. The second opening is disposed on a second edge of the base. The lid includes a third connecting region that has a first projection with a second asymmetrical shape that extends from an outer surface of the lid. The second asymmetrical shape includes a second curved region and a second protruding region that extends from the second curved region. The first projection is disposed on a first edge of the lid. The lid also includes a fourth connecting region that has a second projection with the second asymmetrical shape that extends from the outer surface of the lid. The second projection is disposed on a second edge of the lid. The lid can be coupled to the base so that one of the first connecting region engages with one the third connecting region or the second connecting region engages with one the fourth connecting region.

In some forms, an in-use cover for an electrical device includes a base with an internal volume and a lid connected to the base. The base includes a first connecting region that has a first opening with a first asymmetrical shape that is formed in an outer surface of the base. The first asymmetrical shape includes a first curved region and a first protruding region that extends from the first curved region. The first opening is disposed on a first edge of the base. The base also includes a second connecting region that has a second opening with the first asymmetrical shape that is formed on the outer surface of the base. The second opening is disposed on a second edge of the base. The lid includes a third connecting region that has a first projection with a second asymmetrical shape that extends from an outer surface of the lid. The second asymmetrical shape includes a second curved region and a second protruding region that extends from the second curved region. The first projection is disposed on a first edge of the lid. The lid also includes a fourth connecting region that has a second projection with the second asymmetrical shape that extends from the outer surface of the lid. The second projection is disposed on a second edge of the lid. The lid can be coupled to the base so that one of the first connecting region engages with one the third connecting region or the second connecting region engages with one the fourth connecting region.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawing wherein:

FIG. 1 is a perspective view of a first cover.

FIG. 2 is a perspective view of a base of the cover of FIG. 1.

FIG. 3 is a side view of the base of FIG. 2.

FIG. 4 is a perspective view of a lid of the cover of FIG. 1.

FIG. 5 is a side view of the cover of FIG. 1 in a latched position.

FIG. 6 is a side view of the cover of FIG. 1 in an unlatched position.

FIG. 7 is a side view of the cover of FIG. 1 in an opened position.

FIG. 8 is a perspective view of a second cover.

FIG. 9 is a perspective view of the base of the cover of FIG. 8.

FIG. 10 is a side view of the base of FIG. 9.

FIG. 11 is an upper perspective view of the lid of the base of FIG. 8.

FIG. 12 is a lower perspective view of the lid of FIG. 11.

FIG. 13 is a side view of the cover of FIG. 8 in a latched position.

FIG. 14 is a cross-section of the cover of FIG. 8, viewed along section 14-14, illustrating a position of the pin when the cover is in the latched position.

FIG. 15 is a side view of the cover of FIG. 8 in an unlatched position.

FIG. 16 is a cross-section of the cover of FIG. 15 illustrating a position of the pin when the cover is in the unlatched position.

FIG. 17 is a side view of the cover of FIG. 8 in a partially opened position.

FIG. 18 is a cross-section of the cover of FIG. 17 illustrating a position of the pin when the cover is in the partially opened position.

FIG. 19 is a side view of the cover of FIG. 8 in an opened position.

FIG. 20 is a cross-section of the cover of FIG. 19 illustrating a position of the pin when the cover is in the opened position.

FIG. 21 is a perspective view of a third cover.

FIG. 22 is a perspective view of a base of the cover of FIG. 21.

FIG. 23 is a side view of the base of FIG. 22.

FIG. 24 is a perspective view of a lid of the cover of FIG. 21.

FIG. 25 is a side view of the cover of FIG. 21 in a latched position.

FIG. 26 is a side view of the cover of FIG. 21 in an unlatched position.

FIG. 27 is a side view of the cover of FIG. 21 in an opened position.

FIG. 28 is a perspective view of a fourth cover.

FIG. 29 is a perspective view of a base of the cover of FIG. 28.

FIG. 30 is a perspective view of the base of FIG. 29.

FIG. 31 is an upper perspective view of a lid of the cover of FIG. 28.

FIG. 32 is a lower perspective view of the lid of FIG. 31.

FIG. 33 is a side view of the cover of FIG. 28 in a latched position.

FIG. 34 is a cross-sectional view of the cover of FIG. 28, viewed along section 34--34, illustrating the cover in the latched position.

FIG. 35 is a side view of the cover of FIG. 28 in an unlatched position.

FIG. 36 is a cross-sectional view of the cover of FIG. 35 illustrating the cover in the unlatched position.

FIG. 37 is a side view of the cover of FIG. 28 in a partially opened position.

FIG. 38 is a cross-sectional view of the cover of FIG. 37 illustrating the cover in the partially opened position.

FIG. 39 is a side view of the cover of FIG. 28 in an opened position.

FIG. 40 is a cross-sectional view of the cover of FIG. 39 illustrating the cover in the opened position.

FIG. 41 is a perspective view of a fifth cover.

FIG. 42 is a perspective view of a base of the cover of FIG. 41.

FIG. 43 is a side view of the base of FIG. 42.

FIG. 44 is a perspective view of a lid of the cover of FIG. 41.

FIG. 45 is a side view of the cover of FIG. 41 illustrating a latched position.

FIG. 46 is a side view of the cover of FIG. 41 illustrating an unlatched position.

FIG. 47 is a side view of the cover of FIG. 41 illustrating a partially opened position.

FIG. 48 is a side view of the cover of FIG. 41 illustrating an opened positioned.

FIG. 49 is a perspective view of a sixth cover.

FIG. 50 is a perspective view of a base of the cover of FIG. 49.

FIG. 51 is a side view of the base of FIG. 50.

FIG. 52 is a perspective view of a lid of the cover of FIG. 49.

FIG. 53 is a side view of the cover of FIG. 49 illustrating a latched position.

FIG. 54 is a side view of the cover of FIG. 49 illustrating an unlatched position.

FIG. 55 is a side view of the cover of FIG. 49 illustrating an opened position.

FIG. 56 is a perspective view of a seventh cover.

FIG. 57 is a perspective view of a base of the cover of FIG. 56.

FIG. 58 is a side view of the base of FIG. 57.

FIG. 59 is a perspective view of a lid of the cover of FIG. 56.

FIG. 60 is a side view of the cover of FIG. 56 illustrating a latched position.

FIG. 61 is a side view of the cover of FIG. 56 illustrating an unlatched position.

FIG. 62 is a side view of the cover of FIG. 56 illustrating an opened position.

FIG. 63 is a perspective view of an eighth cover.

FIG. 64 is a perspective view of a base of the cover of FIG. 63.

FIG. 65 is a front view of the base of FIG. 64.

FIG. 66 is a side view of the base of FIG. 64.

FIG. 67 is a perspective view of a lid of the cover of FIG. 63.

FIG. 68 is a cross-sectional view of the cover of FIG. 63 illustrating a first latched position.

FIG. 69 is a cross-sectional view of the cover of FIG. 63 illustrating a first unlatched position.

FIG. 70 is a cross-sectional view of the cover of FIG. 63 illustrating a first opened position.

FIG. 71 is a cross-sectional view of the cover of FIG. 63 illustrating a second latched position.

FIG. 72 is a cross-sectional view of the cover of FIG. 63 illustrating a second unlatched position.

FIG. 73 is a cross-sectional view of the cover of FIG. 63 illustrating a second opened position.

FIG. 74 is a perspective view of a nineth cover with a first lid.

FIG. 75 is a front perspective view of the base of the cover of FIG. 74.

FIG. 76 is a rear perspective view of the base of FIG. 75.

FIG. 77 is a front view of the base of FIG. 75.

FIG. 78 is a side view of the base of FIG. 75.

FIG. 79 is a bottom perspective view of a first lid of the cover of FIG. 74.

FIG. 80 is a cross-sectional view of the cover of FIG. 74 illustrating a latched position.

FIG. 81 is a cross-sectional view of the cover of FIG. 74 illustrating an unlatched position.

FIG. 82 is a cross-sectional view of the cover of FIG. 74 illustrating an opened position.

FIG. 83 is a perspective view of the nineth cover with a second lid.

FIG. 84 is a bottom perspective view of the second lid of the cover of FIG. 83.

FIG. 85 is a cross-sectional view of the cover of FIG. 83 illustrating a latched position.

FIG. 86 is a cross-sectional view of the cover of FIG. 83 illustrating an unlatched position.

FIG. 87 is a cross-sectional view of the cover of FIG. 83 illustrating an opened position.

FIG. 88 is a bottom perspective view of a third lid that is connectable to the base of FIG. 75.

### DETAILED DESCRIPTION

The present disclosure is related to a while-in-use cover that may be used with a variety of electrical devices. The while-in-use cover may be used to house outdoor electrical devices to protect the devices from various forms of weather. The while-in-use cover may also be used with indoor electrical devices.

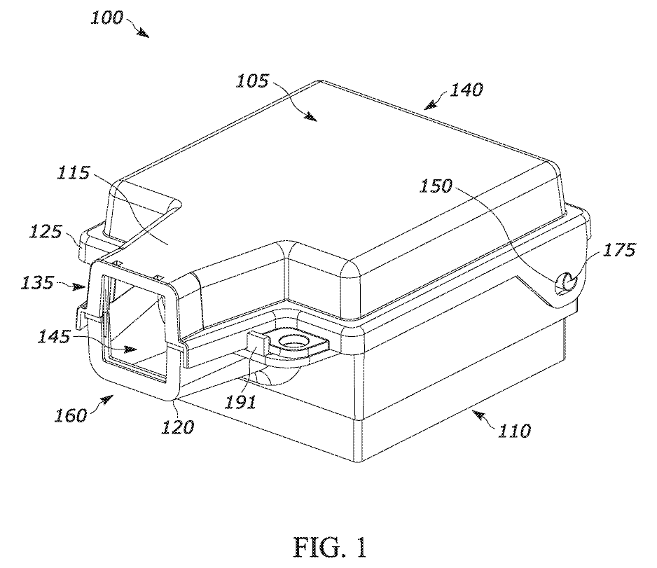

As shown in FIGS. 1 -7, a while-in-use cover 100 may include a lid 105 coupled to a base 110. The lid 105 and the base 110 may have a substantially complementary shape, which may permit the lid 105 to interface with the base 110. In the illustrated example, the lid 105 and the base 110 may have a substantially rectangular shape, although the lid 105 and/or the base 110 may also include a different shape.

In certain forms, the lid 105 may include a neck 115 and the base 110 may include a complementary neck 120. Each neck 115, 120 may extend away from the generally rectangular shape. Each illustrated neck 115, 120 may have a tapered shape (e.g., with a free end being narrower). However, in other examples, the necks 115, 120 may include a constant width.

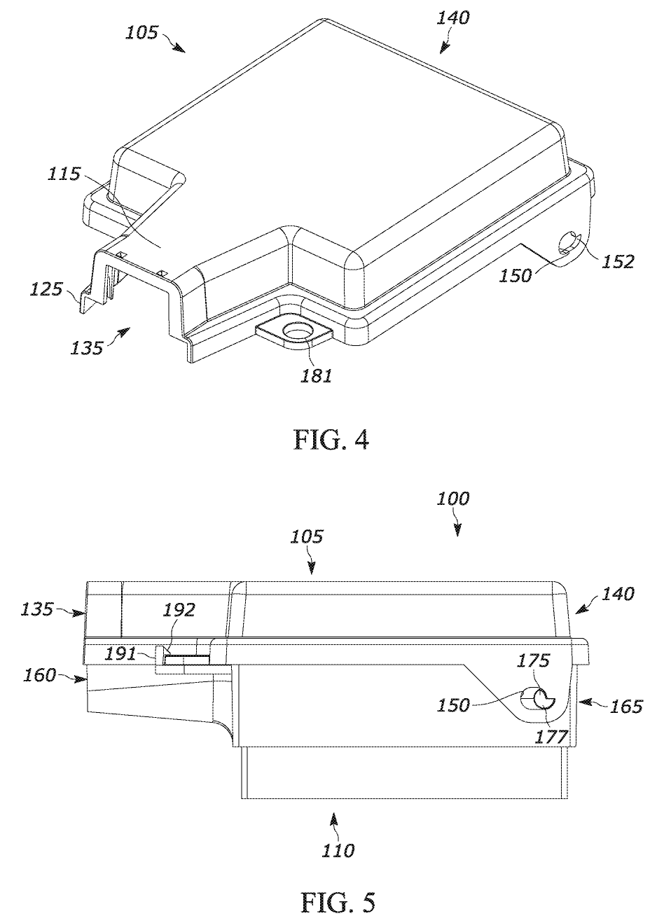

As shown in FIGS. 1 and 4, the lid 105 may include a lip 125 that extends at least partially around a perimeter of the lid 105. For example, the illustrated lip 125 may extend continuously around the perimeter of the lid 105, although in other examples, there may be one or more discontinuities in the lip 125.

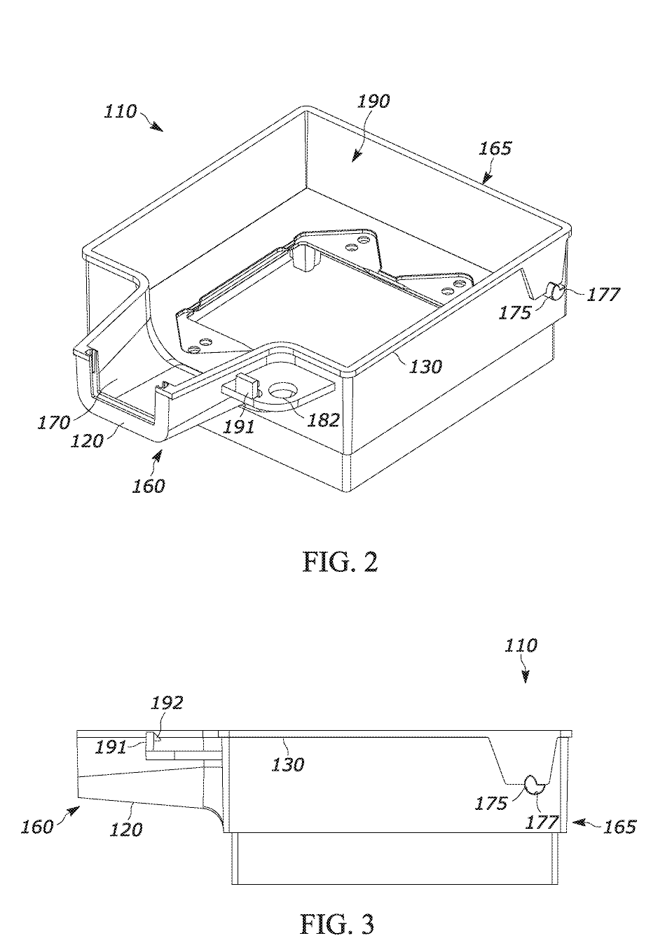

As shown in FIG. 2, the base 110 may include a flange 130 at an upper end. The flange 130 may have a complementary shape to the lip 125 and may be sized and shaped to permit the lip 125 to engage the flange 130. The illustrated example of the flange 130 may be substantially rectangular in shape and may extend outwardly from an outer surface of the base 110.

The lip 125 may have a greater width than a width of the base 110. This may permit the lid 105 to fit over the flange 130 of the base 110 and couple the lid 105 and the base 110 to one another. For example, the lip 125 may be sized to permit the lid 105 to selectively engage the flange 130 of the base 110 with a snap fit, although other types of connections may be used (e.g., a press fit, a friction fit, a magnetic connection, an adhesive, fasteners (e.g., threaded screws), swing arms etc.).

Returning to FIGS. 1 and 4, the lid 105 may include a first end 135 and a second end 140 opposite to the first end 135. The neck 115 may extend to the first end 135. As will be described in more detail below, the neck 115 may be hollow and may include an opening 145 at the first end 135.

Side walls proximate to the second end 140 may include a first hinge portion 150 that may assist in connecting the lid 105 to the base 110. In the illustrated example, the first hinge portion 150 may include a pair of discrete openings spaced apart from one another on opposite walls of the lid 105. Each opening of the first hinge portion 150 may be at least partially rounded in shape.

In some forms, each first hinge portion opening 150 may have an elongated shape that extends in a direction between the first and second ends 135, 140. Each opening 150 may have a partially oval or pill shape. For example, one end of the opening 150 proximate to the first end 135 may be substantially semi-circular in shape. The opposite end of the opening 150 proximate to the second end 140 may have a substantially quarter circular shape, which forms a slot 152. A solid portion of the lid 105 may be adjacent to the quarter-circular portion of the opening 150 (also in a substantially quarter circle shape) so that the ends of the opening 150 are not symmetrical.

The base 110 may similarly include a first end 160 and a second end 165. The neck 120 may extend to the first end 160. As will be described in more detail below, the neck 120 may be hollow and may include an opening 170 at the first end 160.

A second hinge portion 175 may be formed proximate to the second end 165 and may assist in connecting the lid 105 to the base 110. As shown in FIGS. 2 and 3, the second hinge portion 175 may include projections with a similar size as the first hinge portion 150. In other examples, one or more of the openings 150 may be disposed on the base 110 and one or more of the projections 175 may be disposed on the lid 105.

As shown in FIG. 3, each projection 175 may extend from a wall of the base 110 in a direction substantially perpendicular to the direction that extends between the first and second ends 160, 165. Each illustrated projection 175 may also have an at least partially circular shape. For example, each projection 175 may have a substantially three-quarters circle shape, which may be similar to the shape of the opening 150. In other words, the projection 175 may have a semi-circular shape with a protrusion 177 (e.g., having a substantially quarter-circular shape) that has a similar size and shape as the slot 152.

As shown in FIG. 2, the base 110 may include an internal volume 190 that may be at least partially enclosed by the lid 105 (e.g., in the closed position of FIG. 1). The internal volume 190 may at least partially support an electrical device. In some examples, an extension ring may be coupled to the base 110 and provide an additional volume to house the electrical device. The extension ring may be removably coupled to the base 110 or may be integrally formed with the base 110. An extension ring is disclosed in U.S. Application No. 18/891,480, which is incorporated herein by reference in its entirety.

The lid 105 may be connected to the base 110 by aligning the openings 150 with the projections 175. For example, when the first end 135 of the lid 105 is disposed proximate to the first end 160 of the base 110, the shape of each projection 175 may align with the shape of the respective opening 150 so that the protrusion 177 is at least partially received within the slot 152.

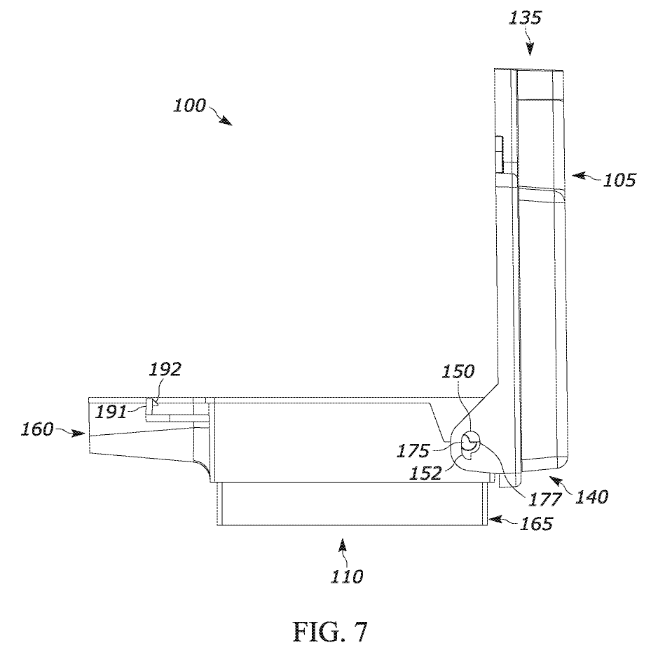

The lid 105 is selectively movable relative to the base 110 between a closed, latched position (see e.g., FIGS. 1 and 5) and an open position (see e.g., FIG. 7). In the closed position, the lid 105 may be secured to the base 110 and may limit the ingress of fluids into a volume of the cover 100. A snap-fit (or other similar connection) may selectively secure the lid 105 to the base 110 and limit the lid 105 from pivoting relative to the base. For example, the base 110 may include a finger 191, which may be formed as a cantilever member with an overhang 192 proximate to the free end (see e.g., FIG. 3). The lid 105 may engage the finger 191 with a snap fit so that in the closed position, the overhang 192 may limit the rotational movement of the lid 105 relative to the base 110.

In some forms, when the overhang 192 engages the first end 135 of the lid 105, the protrusion 177 may be received within the slot 152 of the opening 150. While within the slot 152, the protrusion 177 may further limit the rotational movement of the lid 105 relative to the base 110. For example, an edge of the slot 152 and an edge of the protrusion 177 may engage so limit the lid 105 from rotating toward an opened position.

In some forms, the lid 105 may also include a first locking aperture 181 that may align with a second locking aperture 182 of the base 110 when the lid 105 is in the closed position. A padlock (or other locking mechanism – not shown) may connect to the cover 100 through the first and second locking apertures 181, 182. This may limit unauthorized movement of the lid 105 relative to the base 110.

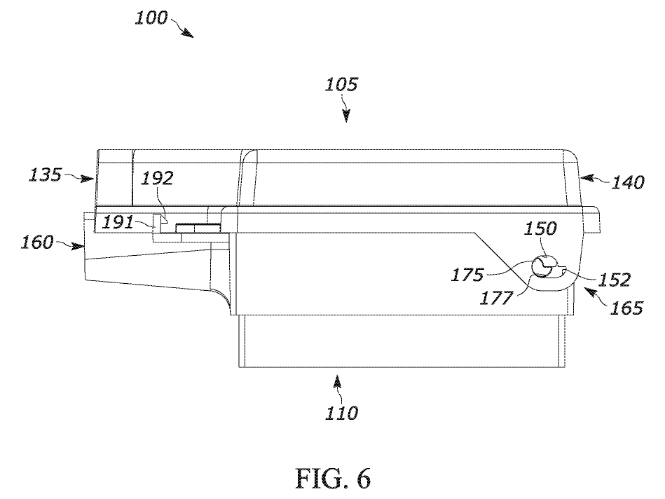

As shown in FIG. 6, the lid 105 may move to an unlatched position where the first end 135 of the lid 105 is disengaged from the overhang 192. For example, the elongated shape of the opening 150 is larger than the size of the projection 175. In other words, the size of the opening 150 may permit the lid 105 to translate relative to the base 110. A user may translate the lid 105 so that the first end 135 of the lid 105 moves away from the first end 160 of the base 110 and toward the second end 165. As the lid 105 translates, the first end 135 of the lid 105 moves beyond the end of the overhang 192. Simultaneously, the projection 175 moves along the opening so that the protrusion 177 moves out of the slot 152. A user may continue to translate the lid 105 until the protrusion 177 has completely exited the slot 152. In this position, neither the overhang 192 nor the protrusion 177 may limit the rotational movement of the lid 105. The lid 105 may still be considered in a closed position (despite not being latched to the base 110) because it still limits access to the internal volume 190.

As shown in FIG. 7, the lid 105 may pivot relative to the base 110 about the projections 175. For example, the lid 105 may pivot in a clockwise direction as viewed in FIG. 7 to expose the internal volume 190. The curved surface of the opening 150 may rotate along the curved surface of the projection 175. The translation between the lid 105 and the base 110 may create spacing between the slot 152 and the protrusion 177 so that the elements do not substantially interfere with the rotational movement of the lid 105.

In some forms, the lid 105 may be able to pivot at least 90 degrees relative to the closed position to provide full access to the internal volume 190. The lid 105 may be able to rest in the opened position (e.g., without assistance from user support), which may enable the user to interact with the electrical device within the internal volume 190 without needed to provide extra support to the lid 105 (e.g., the user may have both hands free).

In some forms, the user may pivot the lid 105 (e.g., counterclockwise as viewed in FIG. 7) so that it returns toward a closed position. Because the lid 105 initially moved away from the finger 191, the lid 105 may be able to pivot toward the closed position without contacting the overhang 192. In this way, the lid 105 may be able to pivot entirely to the closed position (e.g., the unlatched position of FIG. 6) and would not get stuck on the overhang 192 (e.g., which may occur when the lid 105 does not engage the overhang 192 with enough force to cause the snap fit to engage). The user can then manually move the lid 105 from the unlatched position to the latched position to secure the lid 105 in the closed position.

In some forms (not shown), One or more blocking portions may be positioned in the necks 115, 120 to further prevent the ingress of fluids. For example, a single blocking portion may extend across both necks 115, 120 or an individual blocking portion may be positioned in each neck 115, 120. The blocking portion(s) may be constructed from a liquid-resistant material (e.g., a gel) and may substantially seal the necks 115, 120. As described in more detail below, the blocking portion(s) may be repositionable and/or removable to permit an electrical device to extend into the volume of the cover 100.

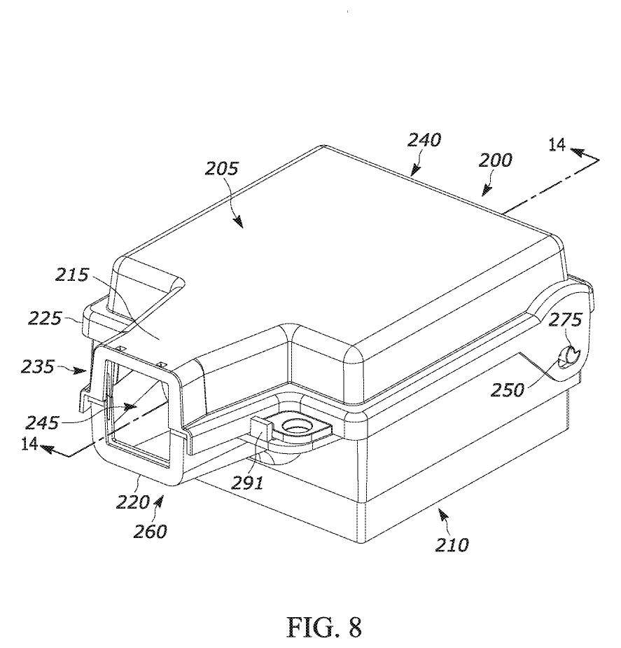

FIGS. 8 -20 illustrate a second example of a cover 200. Only some similarities and differences between the cover 200 and the cover 100 may be described. Similar features include the same reference number plus “100”.

As shown in FIGS. 8 -20, a while-in-use cover 200 may include a lid 205 coupled to a base 210. The lid 205 and the base 210 may have a substantially complementary shape, which may permit the lid 205 to interface with the base 210. In the illustrated example, the lid 205 and the base 210 may have a substantially rectangular shape, although the lid 205 and/or the base 210 may also include a different shape.

In certain forms, the lid 205 may include a neck 215 and the base 210 may include a complementary neck 220. Each neck 215, 220 may extend away from the generally rectangular shape. Each illustrated neck 215, 220 may have a tapered shape (e.g., with a free end being narrower). However, in other examples, the necks 215, 220 may include a constant width.

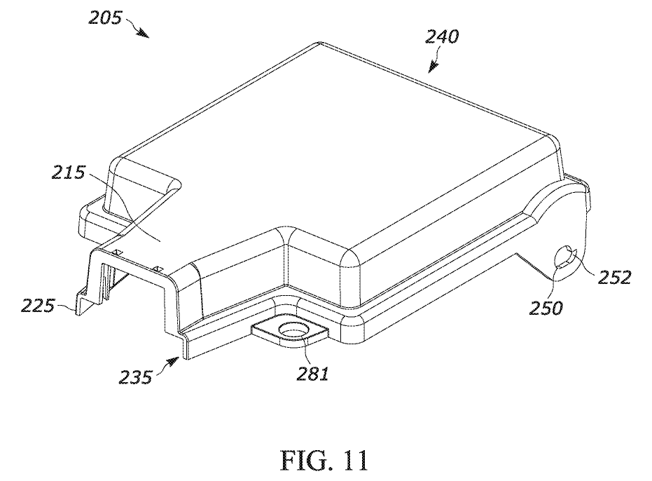

As shown in FIGS. 8, 11, and 12, the lid 205 may include a lip 225 that extends at least partially around a perimeter of the lid 205. For example, the illustrated lip 225 may extend continuously around the perimeter of the lid 205, although in other examples, there may be one or more discontinuities in the lip 225.

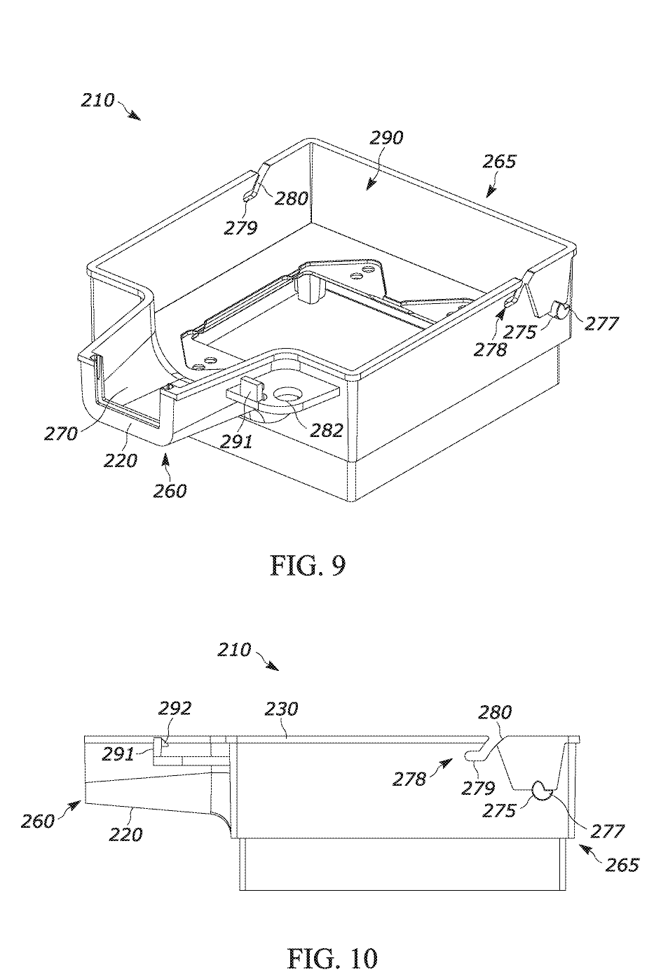

As shown in FIGS. 9 and 10, the base 210 may include a flange 230 at an upper end. The flange 230 may have a complementary shape to the lip 225 and may be sized and shaped to permit the lip 225 to engage the flange 230. The illustrated example of the flange 230 may be substantially rectangular in shape and may extend outwardly from an outer surface of the base 210.

The lip 225 may have a greater width than a width of the base 210. This may permit the lid 205 to fit over the flange 230 of the base 210 and couple the lid 205 and the base 210 to one another. For example, the lip 225 may be sized to permit the lid 205 to selectively engage the flange 230 of the base 210 with a snap fit, although other types of connections may be used (e.g., a press fit, a friction fit, a magnetic connection, an adhesive, fasteners (e.g., threaded screws), swing arms etc.).

Returning to FIGS. 8, 11, and 12, the lid 205 may include a first end 235 and a second end 240 opposite to the first end 235. The neck 215 may extend to the first end 235. As will be described in more detail below, the neck 215 may be hollow and may include an opening 245 at the first end 235.

Side walls proximate to the second end 240 may include a first hinge portion 250 that may assist in connecting the lid 205 to the base 210. In the illustrated example, the first hinge portion 250 may include a pair of discrete openings spaced apart from one another on opposite walls of the lid 205. Each opening of the first hinge portion 250 may be at least partially rounded in shape.

In some forms, each first hinge portion opening 250 may have an elongated shape that extends in a direction between the first and second ends 235, 240. Each opening 250 may have a partially oval or pill shape. For example, one end of the opening 250 proximate to the first end 235 may be substantially semi-circular in shape. The opposite end of the opening 250 proximate to the second end 240 may have a substantially quarter circular shape, which forms a slot 252. A solid portion of the lid 205 may be adjacent to the quarter-circular portion of the opening 250 (also in a substantially quarter circle shape) so that the ends of the opening 250 are not symmetrical.

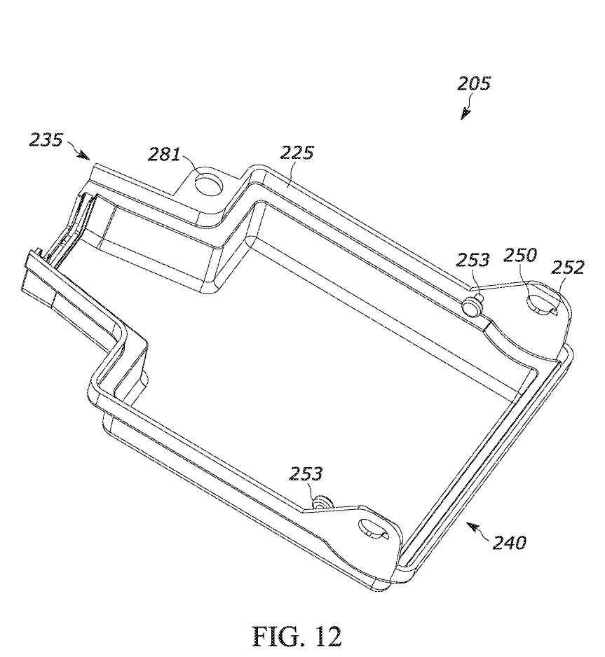

As shown in FIG. 12, the pins 253 may extend from an inner surface of the lid 205 proximate to the openings 250. For example, a single pin 253 may be positioned on either side wall in a position more proximate to the first end 235 than the respective opening 250. In the illustrated example, each pin 253 may be formed as a cantilever member with a substantially circular profile. Each pin 253 may have a first width and a second width that is greater than the first width. The second width may be formed proximate to the free end of the respective pin 253.

As shown in FIGS. 9 and 10, the base 210 may similarly include a first end 260 and a second end 265. The neck 220 may extend to the first end 260. As will be described in more detail below, the neck 220 may be hollow and may include an opening 270 at the first end 260. In some forms, one or more blocking portions may be positioned in the necks 215, 220 to further prevent the ingress of fluids.

A second hinge portion 275 may be formed proximate to the second end 265 and may assist in connecting the lid 205 to the base 210. With continued reference to FIGS. 9 and 10, the second hinge portion 275 may include projections with a similar size as the first hinge portion 250. In other examples, one or more of the openings 150 may be disposed on the base 210 and one or more of the projections 275 may be disposed on the lid 205.

As shown in FIG. 10, each projection 275 may extend from a wall of the base 210 in a direction substantially perpendicular to the direction that extends between the first and second ends 260, 265. Each illustrated projection 275 may also have an at least partially circular shape. For example, each projection 275 may have a substantially three-quarters circle shape, which may be similar to the shape of the opening 250. In other words, the projection 275 may have a semi-circular shape with a protrusion 277 (e.g., having a substantially quarter-circular shape) that has a similar size and shape as the slot 252.

In some forms, a channel 278 may be disposed on a side wall of the base 210 proximate to each projection 275. For example, each channel 278 may be disposed more proximate to the first end 260 than the projection 275. In the illustrated example, the channel 278 may include a first section 279 and a second section 280. The first section 279 may be oriented substantially parallel to the direction between the first and second ends 260, 265 of the base 210. The second section 280 may extend from the first section 279 and may be oriented substantially obliquely with respect to the first section 279. The second section 280 may extend to an edge of the base 210 to provide an ingress location.

As shown in FIG. 9, the base 210 may include an internal volume 290 that may be at least partially enclosed by the lid 205 (e.g., in the closed position of FIG. 8). The internal volume 290 may at least partially support an electrical device. In some examples, an extension ring may be coupled to the base 210 and provide an additional volume to house the electrical device. The extension ring may be removably coupled to the base 110 or may be integrally formed with the base 210.

The lid 205 may be connected to the base 210 by aligning the openings 250 with the projections 275. For example, when the first end 235 of the lid 205 is disposed proximate to the first end 260 of the base 210, the shape of each projection 275 may align with the shape of the respective opening 250 so that the protrusion 277 is at least partially received within the slot 252.

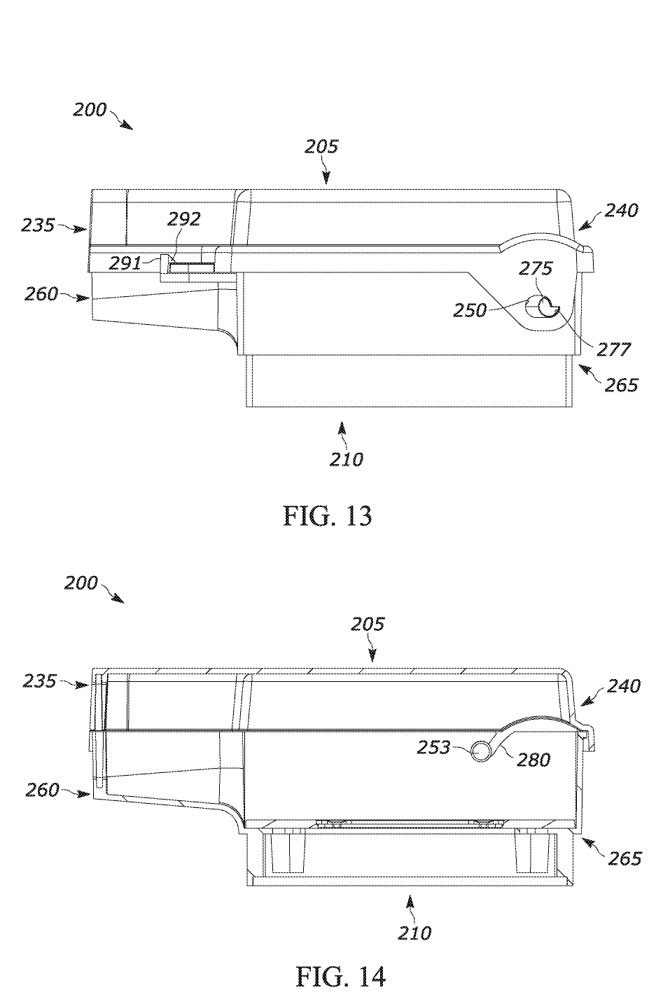

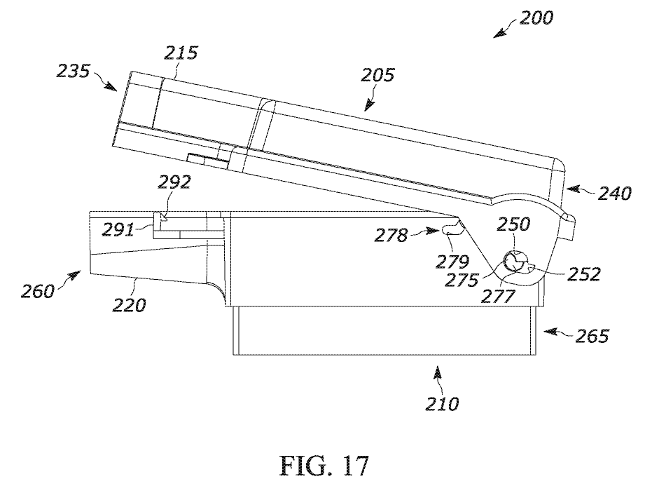

The lid 205 is selectively movable relative to the base 210 between a closed, latched position (see e.g., FIGS. 8 and 13) and an open position (see e.g., FIGS. 17-20). In the closed position, the lid 205 may be secured to the base 210 and may limit the ingress of fluids into a volume of the cover 200. A snap-fit (or other similar connection) may selectively secure the lid 205 to the base 210 and limit the lid 205 from pivoting relative to the base. For example, the base 210 may include a finger 291, which may be formed as a cantilever member with an overhang 292 proximate to the free end (see e.g., FIG. 10). The lid 205 may engage the finger 291 with a snap fit so that in the closed position, the overhang 292 may limit the rotational movement of the lid 205 relative to the base 210.

As shown in FIG. 13, when the overhang 292 engages the first end 235 of the lid 205, the protrusion 277 may be received within the slot 252 of the opening 250. While within the slot 252, the protrusion 277 may further limit the rotational movement of the lid 205 relative to the base 210. For example, an edge of the slot 252 and an edge of the protrusion 277 may engage so limit the lid 105 from rotating toward an opened position.

As shown in FIG. 14, each pin 253 of the lid 205 may be received in a respective one of the channels 278 of the base 210. For example, the width of the channel 278 may accommodate the first width of the pin 253. The second width of the pin 253 may be greater than the width of the channel 278 and may limit the pin 253 from translating in a direction substantially perpendicular to the channel 278. In the latched position, each pin 253 may be disposed at an end of the first section 279 of the channel 278.

In some forms, the lid 205 may also include a first locking aperture 281 that may align with a second locking aperture 282 of the base 210 when the lid 205 is in the closed position. A padlock (or other locking mechanism – not shown) may connect to the cover 200 through the first and second locking apertures 281, 282. This may limit unauthorized movement of the lid 205 relative to the base 210.

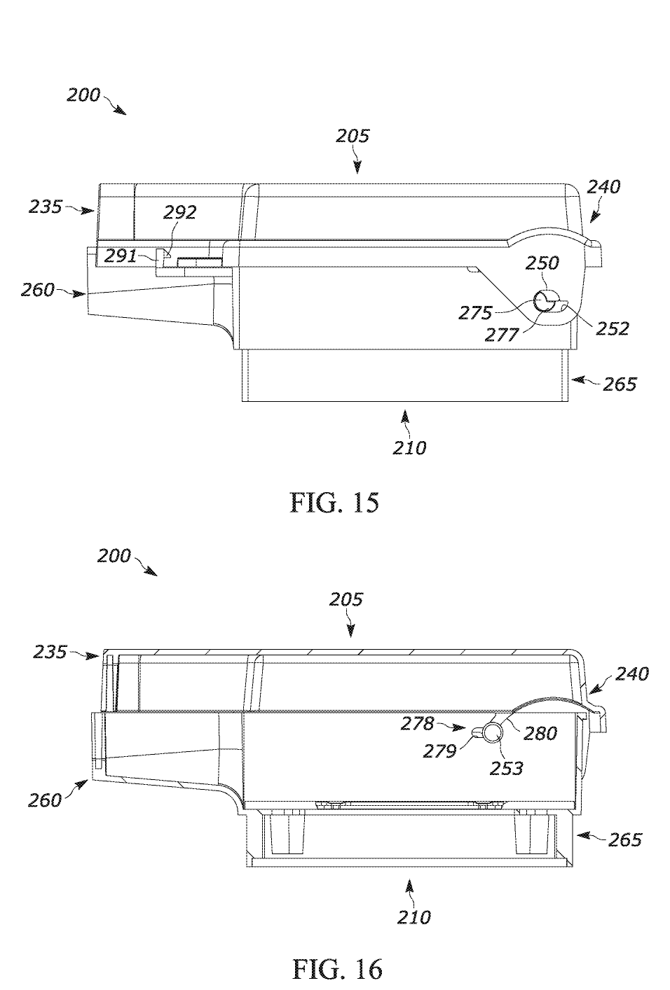

As shown in FIG. 15, the lid 205 may move to an unlatched position where the first end 235 of the lid 205 is disengaged from the overhang 292. For example, the elongated shape of the opening 250 is larger than the size of the projection 275. In other words, the size of the opening 250 may permit the lid 205 to translate relative to the base 210. A user may translate the lid 205 so that the first end 235 of the lid 205 moves away from the first end 260 of the base 210 and toward the second end 265. As the lid 205 translates, the first end 235 of the lid 205 moves beyond the end of the overhang 292. Simultaneously, the projection 275 moves along the opening so that the protrusion 277 moves out of the slot 252. A user may continue to translate the lid 105 until the protrusion 277 has completely exited the slot 252. In this position, neither the overhang 292 nor the protrusion 277 may limit the rotational movement of the lid 205. The lid 205 may still be considered in a closed position (despite not being latched to the base 210) because it still limits access to the internal volume 290.

As shown in FIG. 16, each pin 253 may move along the respective channel 278 as the lid 205 moves between the latched and unlatched positions. More specifically, each pin 253 may translate along the first section 279 of the respective channel 278. In the unlatched position, each pin 253 may be disposed at an end of the first section 279 and proximate to the respective second section 280.

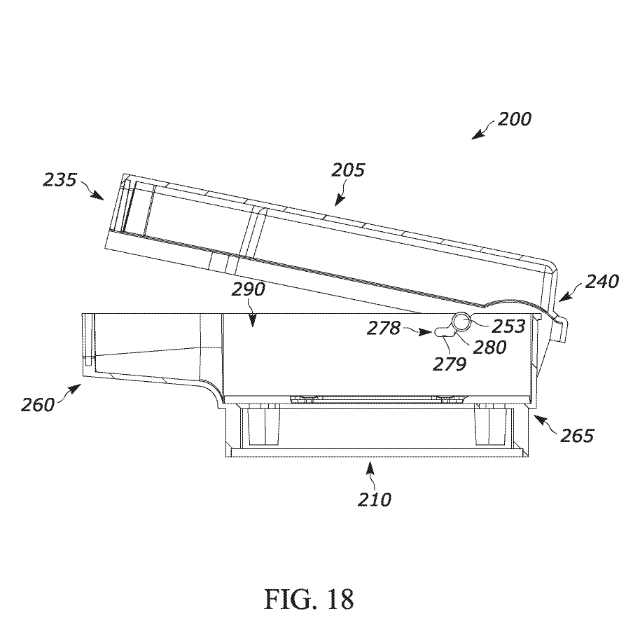

As shown in FIGS. 17 and 18, the lid 205 may pivot relative to the base 210 about the projections 275. For example, the lid 205 may pivot in a clockwise direction as viewed in FIGS. 17 and 18 to expose the internal volume 290. The curved surface of the opening 250 may rotate along the curved surface of the projection 275. The translation between the lid 205 and the base 210 may create spacing between the slot 252 and the protrusion 277 so that the elements do not substantially interfere with the rotational movement of the lid 205.

As shown in FIG. 18, each pin 253 may travel along the second section 280 of the respective channel 278 as the lid 205 moves from the unlatched position to the opened position. The inclination of the second section 280 may correspond to the movement of the lid 205 so that the pins 253 are guided through the channel 278 and are not substantially rubbing against the wall of the respective channel 278.

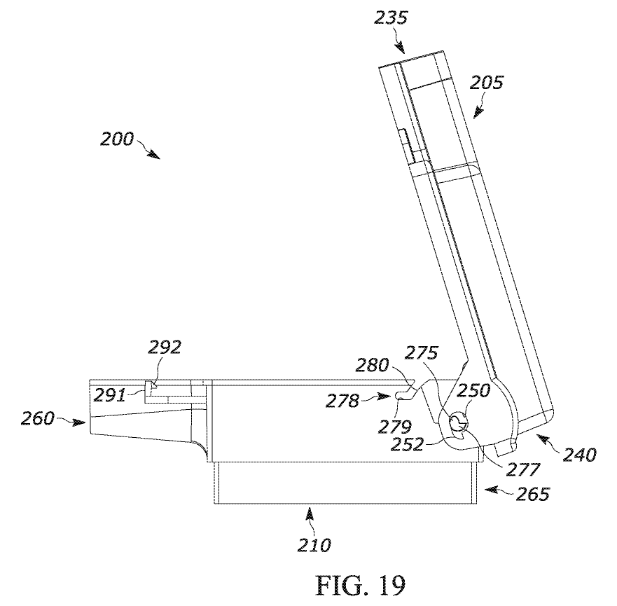

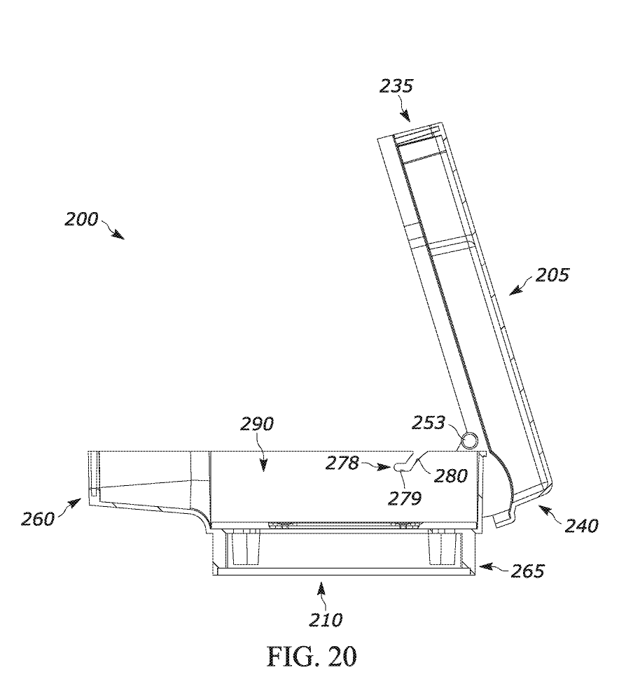

As shown in FIGS. 19 and 20, the lid 205 may continue to pivot in the opened position to a position about least 90 degrees relative to the closed position to provide full access to the internal volume 290. The lid 205 may be able to rest in the opened position (e.g., without assistance from user support), which may enable the user to interact with the electrical device within the internal volume 290 without needed to provide extra support to the lid 205 (e.g., the user may have both hands free).

As shown in FIG. 20, the rotation of the lid 205 relative to the base 210 may cause the pins 253 to exit the respective channels 278. The pins 253 may ride along the upper edge of the base 210 as the lid 205 continues to pivot toward the fully opened position.

In some forms, the user may pivot the lid 205 (e.g., counterclockwise as viewed in FIGS. 19 and 20) so that it returns toward a closed position. Because the lid 205 initially moved away from the finger 291, the lid 205 may be able to pivot toward the closed position without contacting the overhang 292. In this way, the lid 205 may be able to pivot entirely to the closed position (e.g., the unlatched position of FIGS. 15 and 16) and would not get stuck on the overhang 292 (e.g., which may occur when the lid 205 does not engage the overhang 292 with enough force to cause the snap fit to engage). The user can then manually move the lid 205 from the unlatched position to the latched position to secure the lid 205 in the closed position. As the lid 205 returns toward the closed position, the movement of the lid 205 may cause the pins 253 to reenter the respective channel 278 and move along the first and second sections 279, 280 of the channel 278 as the lid 205 returns toward the closed position.

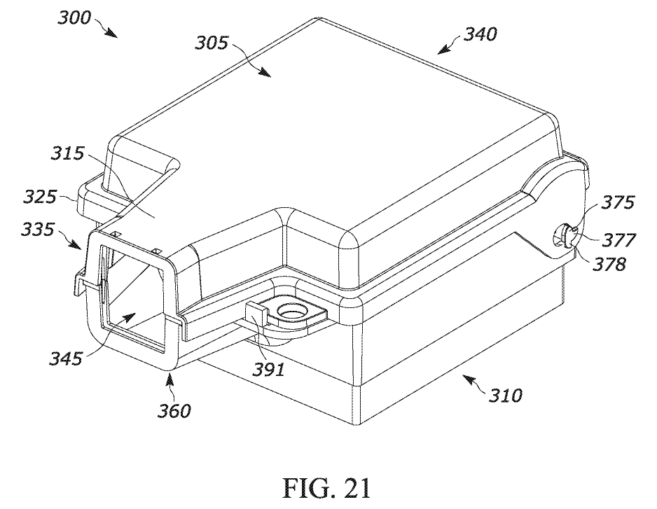

FIGS. 21-27 illustrate a third example of a cover 300. Only some similarities and differences between the cover 300 and the cover 100 may be described. Similar features include the same reference number plus “200”.

As shown in FIGS. 21-27, a while-in-use cover 300 may include a lid 305 coupled to a base 310. The lid 305 and the base 310 may have a substantially complementary shape, which may permit the lid 305 to interface with the base 310. In the illustrated example, the lid 305 and the base 310 may have a substantially rectangular shape, although the lid 305 and/or the base 310 may also include a different shape.

In certain forms, the lid 305 may include a neck 315 and the base 310 may include a complementary neck 320. Each neck 315, 320 may extend away from the generally rectangular shape. Each illustrated neck 315, 320 may have a tapered shape (e.g., with a free end being narrower). However, in other examples, the necks 315, 320 may include a constant width.

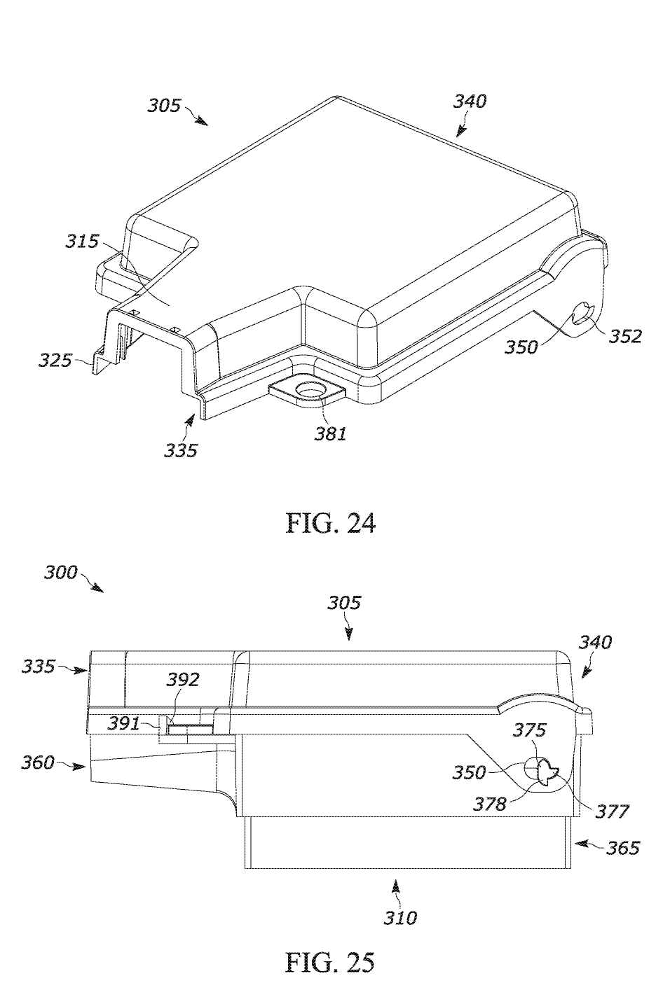

As shown in FIGS. 21 and 24, the lid 305 may include a lip 325 that extends at least partially around a perimeter of the lid 305. For example, the illustrated lip 325 may extend continuously around the perimeter of the lid 305, although in other examples, there may be one or more discontinuities in the lip 325.

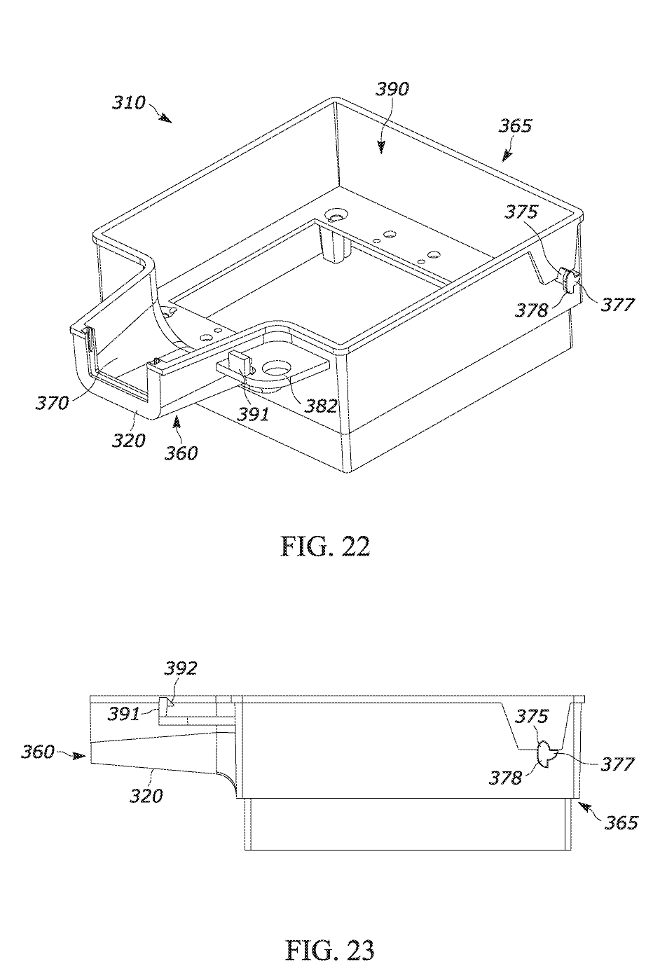

As shown in FIG. 22, the base 310 may include a flange 330 at an upper end. The flange 330 may have a complementary shape to the lip 325 and may be sized and shaped to permit the lip 325 to engage the flange 330. The illustrated example of the flange 330 may be substantially rectangular in shape and may extend outwardly from an outer surface of the base 310.

The lip 325 may have a greater width than a width of the base 310. This may permit the lid 305 to fit over the flange 330 of the base 310 and couple the lid 305 and the base 310 to one another. For example, the lip 325 may be sized to permit the lid 305 to selectively engage the flange 330 of the base 310 with a snap fit, although other types of connections may be used (e.g., a press fit, a friction fit, a magnetic connection, an adhesive, fasteners (e.g., threaded screws), swing arms etc.).

Returning to FIGS. 21 and 24, the lid 305 may include a first end 335 and a second end 340 opposite to the first end 335. The neck 315 may extend to the first end 335. As will be described in more detail below, the neck 315 may be hollow and may include an opening 345 at the first end 335.

Side walls proximate to the second end 340 may include a first hinge portion 350 that may assist in connecting the lid 305 to the base 310. In the illustrated example, the first hinge portion 350 may include a pair of discrete openings spaced apart from one another on opposite walls of the lid 305. Each opening of the first hinge portion 350 may be at least partially rounded in shape.

In some forms, each first hinge portion opening 350 may have an elongated shape that extends in a direction between the first and second ends 335, 340. Each opening 350 may have a partially oval or pill shape. For example, one end of the opening 350 proximate to the first end 335 may be substantially semi-circular in shape. The opposite end of the opening 350 proximate to the second end 340 may have a substantially quarter circular shape, which forms a slot 352. A solid portion of the lid 305 may be adjacent to the quarter-circular portion of the opening 350 (also in a substantially quarter circle shape) so that the ends of the opening 350 are not symmetrical.

The base 310 may similarly include a first end 360 and a second end 365. The neck 320 may extend to the first end 360. As will be described in more detail below, the neck 320 may be hollow and may include an opening 370 at the first end 360.

A second hinge portion 375 may be formed proximate to the second end 365 and may assist in connecting the lid 305 to the base 310. As shown in FIGS. 22 and 23, the second hinge portion 375 may include projections with a similar size as the first hinge portion 350. In other examples, one or more of the openings 350 may be disposed on the base 310 and one or more of the projections 375 may be disposed on the lid 305.

As shown in FIG. 23, each projection 375 may extend from a wall of the base 310 in a direction substantially perpendicular to the direction that extends between the first and second ends 360, 365. Each illustrated projection 375 may also have an at least partially circular shape. For example, each projection 375 may have a substantially three-quarters circle shape, which may be similar to the shape of the opening 350. In other words, the projection 375 may have a semi-circular shape with a first protrusion 377 (e.g., having a substantially quarter-circular shape). In the illustrated example, the projection 375 may also include a second protrusion 378 (e.g., with a similar shape to the first protrusion 377) that has a similar size and shape as the slot 352. The second protrusion 378 may have substantially the same orientation as the first protrusion and may be offset from the first protrusion 377 (e.g., by approximately 90 degrees).

As shown in FIG. 22, the base 310 may include an internal volume 390 that may be at least partially enclosed by the lid 305 (e.g., in the closed position of FIG. 21). The internal volume 390 may at least partially support an electrical device. In some examples, an extension ring may be coupled to the base 310 and provide an additional volume to house the electrical device. The extension ring may be removably coupled to the base 310 or may be integrally formed with the base 310.

The lid 305 may be connected to the base 310 by aligning the openings 350 with the projections 375. For example, when the first end 335 of the lid 305 is disposed proximate to the first end 360 of the base 310, the shape of each projection 375 may align with the shape of the respective opening 350 so that the first protrusion 377 is at least partially received within the slot 352. The second protrusion 378 may be oriented substantially 90 degrees from the first protrusion 377 and may be disposed at least partially outside of the opening 350.

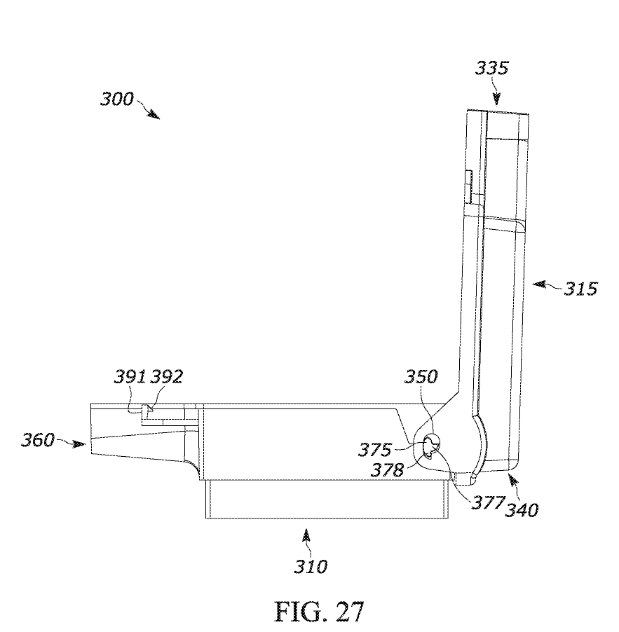

The lid 305 is selectively movable relative to the base 310 between a closed, latched position (see e.g., FIGS. 21 and 25) and an open position (see e.g., FIG. 27). In the closed position, the lid 305 may be secured to the base 310 and may limit the ingress of fluids into a volume of the cover 300. A snap-fit (or other similar connection) may selectively secure the lid 305 to the base 310 and limit the lid 305 from pivoting relative to the base. For example, the base 310 may include a finger 391, which may be formed as a cantilever member with an overhang 392 proximate to the free end (see e.g., FIG. 3). The lid 305 may engage the finger 391 with a snap fit so that in the closed position, the overhang 392 may limit the rotational movement of the lid 305 relative to the base 310.

In some forms, when the overhang 392 engages the first end 335 of the lid 305, the first protrusion 377 may be received within the slot 352 of the opening 350. While within the slot 352, the first protrusion 377 may further limit the rotational movement of the lid 305 relative to the base 310. For example, an edge of the slot 352 and an edge of the first protrusion 377 may engage so limit the lid 305 from rotating toward an opened position.

In some forms, the lid 305 may also include a first locking aperture 381 that may align with a second locking aperture 382 of the base 310 when the lid 305 is in the closed position. A padlock (or other locking mechanism – not shown) may connect to the cover 300 through the first and second locking apertures 381, 382. This may limit unauthorized movement of the lid 305 relative to the base 310.

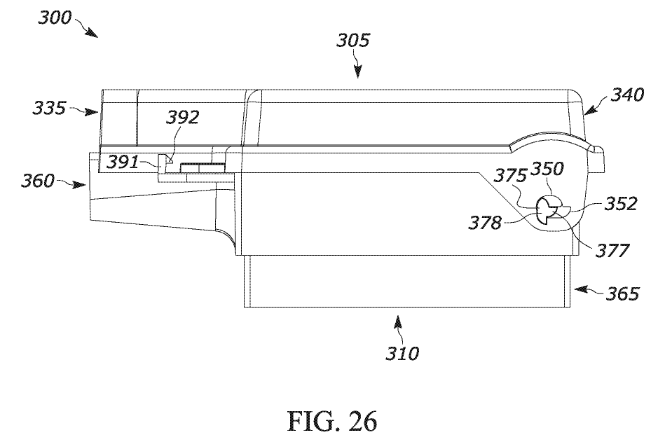

As shown in FIG. 26, the lid 305 may move to an unlatched position where the first end 335 of the lid 305 is disengaged from the overhang 392. For example, the elongated shape of the opening 350 is larger than the size of the projection 375. In other words, the size of the opening 150 may permit the lid 305 to translate relative to the base 310. A user may translate the lid 305 so that the first end 335 of the lid 305 moves away from the first end 360 of the base 310 and toward the second end 365. As the lid 305 translates, the first end 335 of the lid 305 moves beyond the end of the overhang 392. Simultaneously, the projection 375 moves along the opening so that the first protrusion 377 moves out of the slot 352. A user may continue to translate the lid 305 until the first protrusion 377 has completely exited the slot 352. In this position, neither the overhang 392 nor the first protrusion 377 may limit the rotational movement of the lid 305. The lid 305 may still be considered in a closed position (despite not being latched to the base 310) because it still limits access to the internal volume 390.

As shown in FIG. 27, the lid 305 may pivot relative to the base 310 about the projections 375. For example, the lid 305 may pivot in a clockwise direction as viewed in FIG. 27 to expose the internal volume 390. The curved surface of the opening 350 may rotate along the curved surface of the projection 375. The translation between the lid 305 and the base 310 may create spacing between the slot 352 and the first protrusion 377 so that the elements do not substantially interfere with the rotational movement of the lid 305.

In some forms, the lid 305 may be able to pivot at least 90 degrees relative to the closed position to provide full access to the internal volume 390. In this position, the second protrusion 378 may be aligned with the slot 352 and may be received within the slot 352. The second protrusion 378 may limit the rotation of the lid 305 relative to the base 310 so that the lid 305 may be able to rest in the opened position (e.g., without assistance from user support), which may enable the user to interact with the electrical device within the internal volume 390 without needed to provide extra support to the lid 305 (e.g., the user may have both hands free).

In some forms, the user may pivot the lid 305 (e.g., counterclockwise as viewed in FIG. 27) so that it returns toward a closed position. The user may first translate the lid 305 in an upward direction (e.g., as viewed FIG. 27) to cause the second protrusion 378 to translate out of the slot 352. The lid 305 may then pivot without interference from the engagement of the second protrusion 378 with the slot 352. Because the lid 305 initially moved away from the finger 391, the lid 305 may be able to pivot toward the closed position without contacting the overhang 392. In this way, the lid 305 may be able to pivot entirely to the closed position (e.g., the unlatched position of FIG. 26) and would not get stuck on the overhang 392 (e.g., which may occur when the lid 305 does not engage the overhang 392 with enough force to cause the snap fit to engage). The user can then manually move the lid 305 from the unlatched position to the latched position to secure the lid 305 in the closed position.

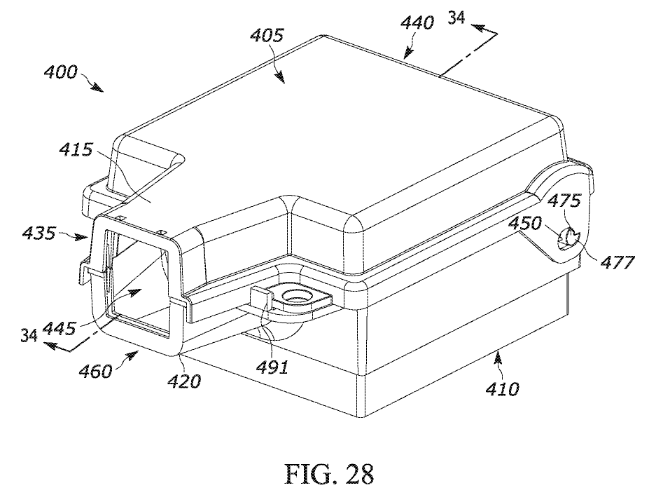

FIGS. 28-40 illustrate a fourth example of a cover 400. Only some similarities and differences between the cover 400 and the cover 100 may be described. Similar features include the same reference number plus “300”.

As shown in FIGS. 28-40, a while-in-use cover 400 may include a lid 405 coupled to a base 410. The lid 405 and the base 410 may have a substantially complementary shape, which may permit the lid 405 to interface with the base 410. In the illustrated example, the lid 405 and the base 410 may have a substantially rectangular shape, although the lid 405 and/or the base 410 may also include a different shape.

In certain forms, the lid 405 may include a neck 415 and the base 410 may include a complementary neck 420. Each neck 415, 420 may extend away from the generally rectangular shape. Each illustrated neck 415, 420 may have a tapered shape (e.g., with a free end being narrower). However, in other examples, the necks 415, 420 may include a constant width.

As shown in FIGS. 28, 31, and 32, the lid 405 may include a lip 425 that extends at least partially around a perimeter of the lid 405. For example, the illustrated lip 425 may extend continuously around the perimeter of the lid 405, although in other examples, there may be one or more discontinuities in the lip 425.

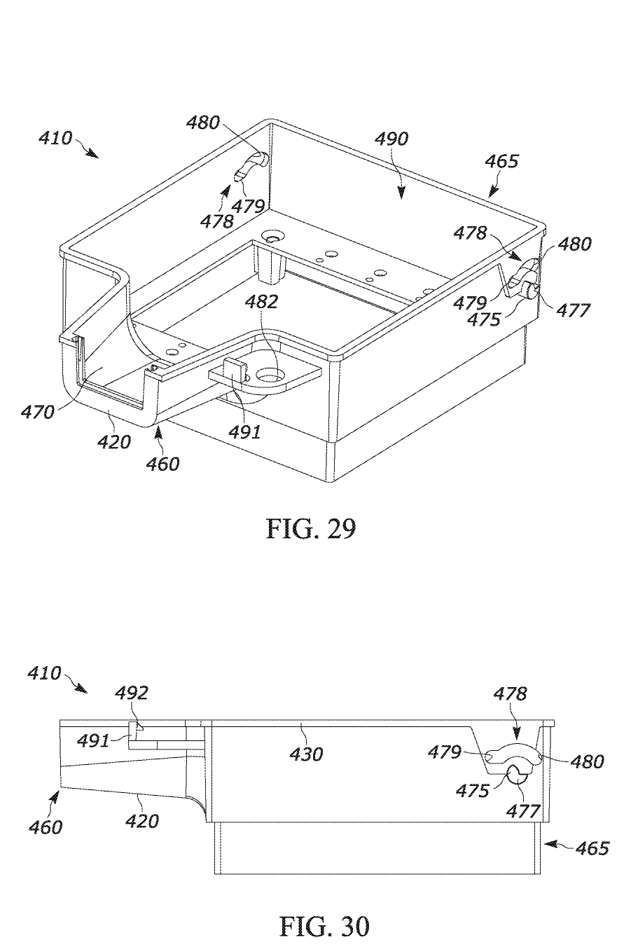

As shown in FIG. 29, the base 410 may include a flange 430 at an upper end. The flange 430 may have a complementary shape to the lip 425 and may be sized and shaped to permit the lip 425 to engage the flange 430. The illustrated example of the flange 430 may be substantially rectangular in shape and may extend outwardly from an outer surface of the base 410.

The lip 425 may have a greater width than a width of the base 410. This may permit the lid 405 to fit over the flange 430 of the base 410 and couple the lid 405 and the base 410 to one another. For example, the lip 425 may be sized to permit the lid 405 to selectively engage the flange 430 of the base 410 with a snap fit, although other types of connections may be used (e.g., a press fit, a friction fit, a magnetic connection, an adhesive, fasteners (e.g., threaded screws), swing arms etc.).

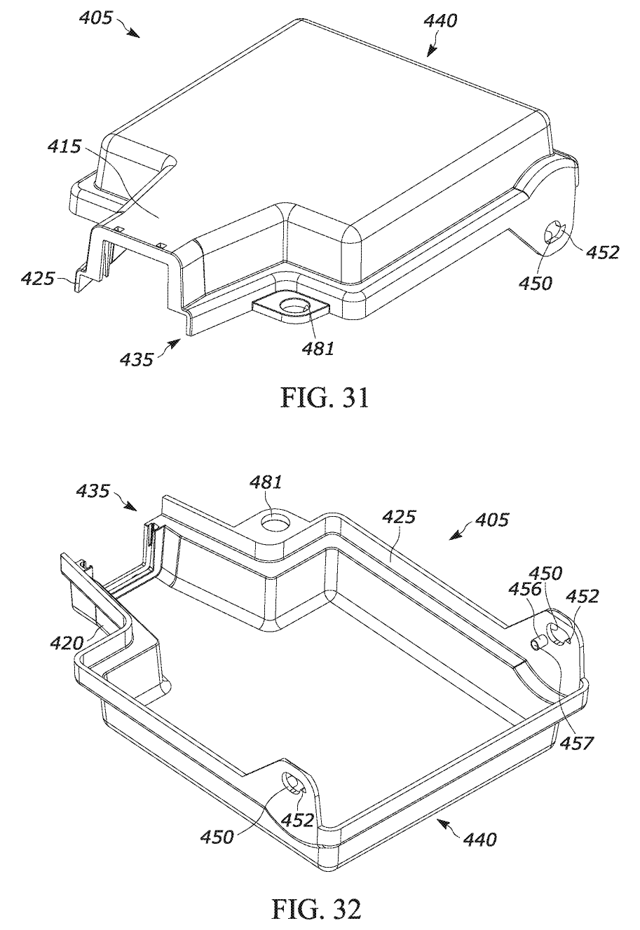

Returning to FIGS. 31 and 32, the lid 405 may include a first end 435 and a second end 440 opposite to the first end 435. The neck 415 may extend to the first end 435. As will be described in more detail below, the neck 415 may be hollow and may include an opening 445 at the first end 435.

Side walls proximate to the second end 440 may include a first hinge portion 450 that may assist in connecting the lid 405 to the base 410. In the illustrated example, the first hinge portion 450 may include a pair of discrete openings spaced apart from one another on opposite walls of the lid 405. Each opening of the first hinge portion 450 may be at least partially rounded in shape.

In some forms, each first hinge portion opening 450 may have an elongated shape that extends in a direction between the first and second ends 435, 440. Each opening 450 may have a partially oval or pill shape. For example, one end of the opening 450 proximate to the first end 435 may be substantially semi-circular in shape. The opposite end of the opening 450 proximate to the second end 440 may have a substantially quarter circular shape, which forms a slot 452. A solid portion of the lid 405 may be adjacent to the quarter-circular portion of the opening 450 (also in a substantially quarter circle shape) so that the ends of the opening 450 are not symmetrical.

As shown in FIG. 32, some forms of the lid 405 may include pins 456 that extend from an inner surface. For example, a pin 456 may be disposed proximate to each of the openings 450, and the pins 456 may be disposed more proximate to the first end 435 than the distance between the opening 450 and the first end 435.

In some forms, each pin 456 may include a hollow center with an opening 457. As described in more detail below, the opening 457 may receive a fastener for connecting the lid 405 to the base 410.

The base 410 may similarly include a first end 460 and a second end 465. The neck 420 may extend to the first end 460. As will be described in more detail below, the neck 420 may be hollow and may include an opening 470 at the first end 460. In some forms, one or more blocking portions may be positioned in the necks 415, 420 to further prevent the ingress of fluids.

A second hinge portion 475 may be formed proximate to the second end 465 and may assist in connecting the lid 405 to the base 410. As shown in FIGS. 29 and 30, the second hinge portion 475 may include projections with a similar size as the first hinge portion 450. In other examples, one or more of the openings 450 may be disposed on the base 410 and one or more of the projections 475 may be disposed on the lid 405.

As shown in FIG. 30, each projection 475 may extend from a wall of the base 410 in a direction substantially perpendicular to the direction that extends between the first and second ends 460, 465. Each illustrated projection 475 may also have an at least partially circular shape. For example, each projection 475 may have a substantially three-quarters circle shape, which may be similar to the shape of the opening 450. In other words, the projection 475 may have a semi-circular shape with a protrusion 477 (e.g., having a substantially quarter-circular shape) that has a similar size and shape as the slot 452.

As shown in FIG. 29, the base 410 may include an internal volume 490 that may be at least partially enclosed by the lid 405 (e.g., in the closed position of FIG. 28). The internal volume 490 may at least partially support an electrical device. In some examples, an extension ring may be coupled to the base 410 and provide an additional volume to house the electrical device. The extension ring may be removably coupled to the base 410 or may be integrally formed with the base 410.

With continued reference to FIGS. 29 and 30, a channel 478 may be disposed on a side wall of the base 410 proximate to each projection 475. For example, each channel 478 may be disposed above the respective projection 475 (e.g., more proximate to an opening to the internal volume 490). In the illustrated example, the channel 478 may include a first section 479 and a second section 480. The first section 479 may be oriented substantially parallel to the direction between the first and second ends 460, 465 of the base 410. The second section 480 may extend from the first section 479 and may follow a curved path. The channel 478 may be spaced apart from the upper edge of the base 410 so that the channel 478 has a fully defined perimeter.

The lid 405 may be connected to the base 410 by aligning the openings 450 with the projections 475. For example, when the first end 435 of the lid 405 is disposed proximate to the first end 460 of the base 410, the shape of each projection 475 may align with the shape of the respective opening 450 so that the protrusion 477 is at least partially received within the slot 452.

In this position, each pin 456 may be received within the channel 478. For example, each pin 456 may have a maximum width that is less than a width of the channel 478 permitting each pin to extend at least partially through the respective first section 479 of the channel 478. As shown in FIG. 34, a fastener 483 may connect to each pin 456 from within the internal volume 490. The fastener 483 may further couple the lid 405 to the base 410 and may have a larger width than the channel 478 to limit unintended or unauthorized removal of the lid 405 from the base 410.

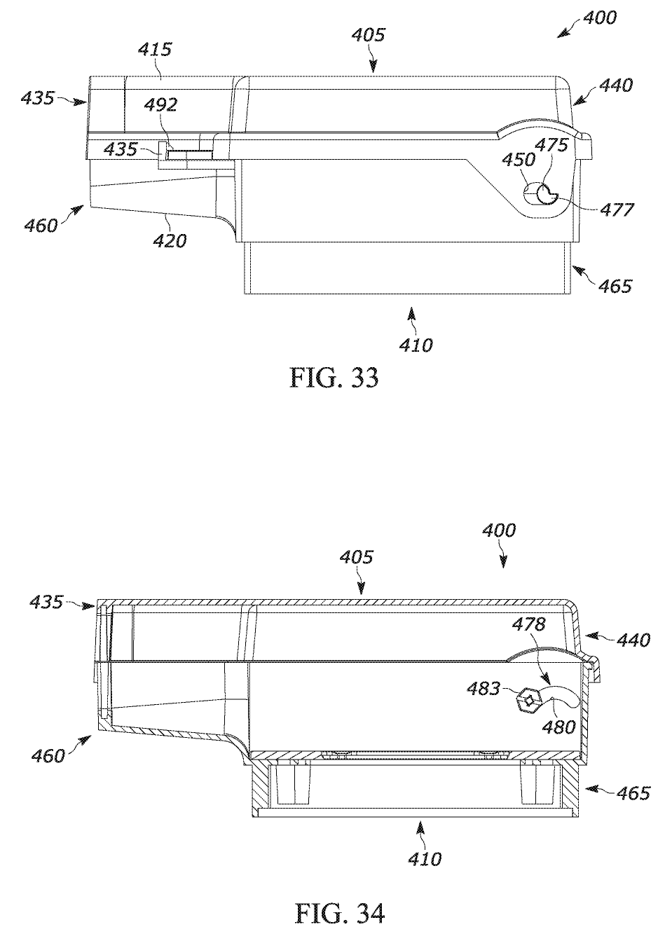

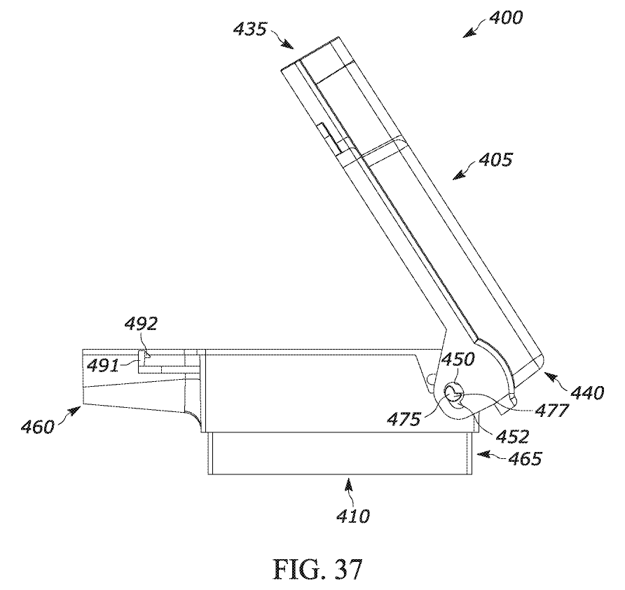

The lid 405 is selectively movable relative to the base 410 between a closed, latched position (see e.g., FIGS. 28 and 33) and an open position (see e.g., FIGS. 37-40). In the closed position, the lid 405 may be secured to the base 410 and may limit the ingress of fluids into a volume of the cover 400. A snap-fit (or other similar connection) may selectively secure the lid 405 to the base 410 and limit the lid 405 from pivoting relative to the base. For example, the base 410 may include a finger 491, which may be formed as a cantilever member with an overhang 492 proximate to the free end (see e.g., FIG. 30). The lid 405 may engage the finger 491 with a snap fit so that in the closed position, the overhang 492 may limit the rotational movement of the lid 405 relative to the base 410.

In some forms, when the overhang 492 engages the first end 435 of the lid 405, the protrusion 477 may be received within the slot 452 of the opening 450. While within the slot 452, the protrusion 477 may further limit the rotational movement of the lid 405 relative to the base 410. For example, an edge of the slot 452 and an edge of the protrusion 477 may engage so limit the lid 405 from rotating toward an opened position.

In some forms, the lid 405 may also include a first locking aperture 481 that may align with a second locking aperture 482 of the base 410 when the lid 405 is in the closed position. A padlock (or other locking mechanism – not shown) may connect to the cover 400 through the first and second locking apertures 481, 482. This may limit unauthorized movement of the lid 405 relative to the base 410.

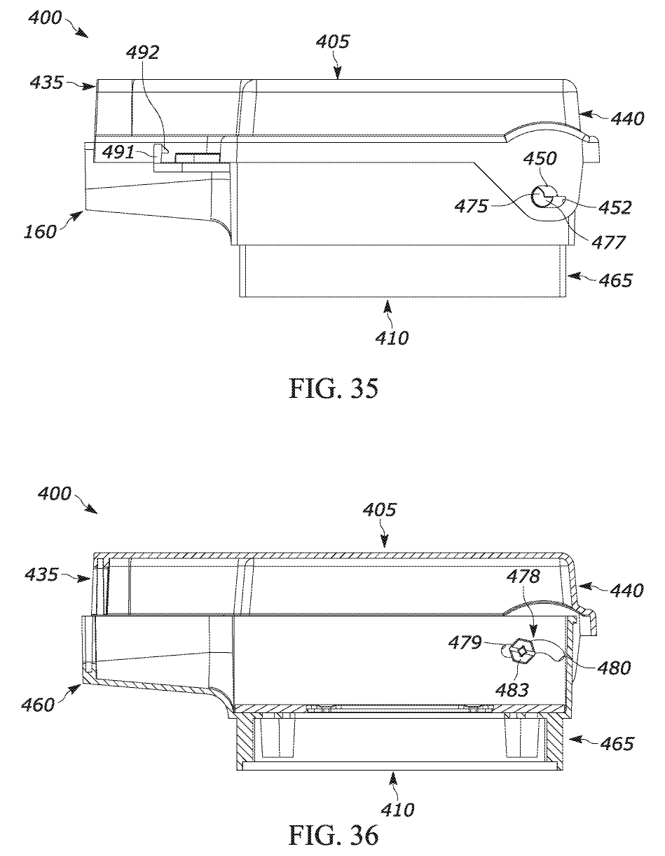

As shown in FIGS. 35 and 36, the lid 405 may move to an unlatched position where the first end 435 of the lid 405 is disengaged from the overhang 492. For example, the elongated shape of the opening 450 is larger than the size of the projection 475. In other words, the size of the opening 450 may permit the lid 405 to translate relative to the base 410. A user may translate the lid 405 so that the first end 435 of the lid 405 moves away from the first end 460 of the base 410 and toward the second end 465. As the lid 405 translates, the first end 435 of the lid 405 moves beyond the end of the overhang 492. Simultaneously, the projection 475 moves along the opening so that the protrusion 477 moves out of the slot 452. A user may continue to translate the lid 405 until the protrusion 477 has completely exited the slot 452. In this position, neither the overhang 492 nor the protrusion 477 may limit the rotational movement of the lid 405. The lid 405 may still be considered in a closed position (despite not being latched to the base 410) because it still limits access to the internal volume 490.

As shown in FIG. 36, each pin 456 may translate along the channel 478 as the lid 405 moves between the latched and unlatched positions. For example, each pin 456 may translate along the length of the respective first section 479 to the transition between the first and second sections 479, 480.

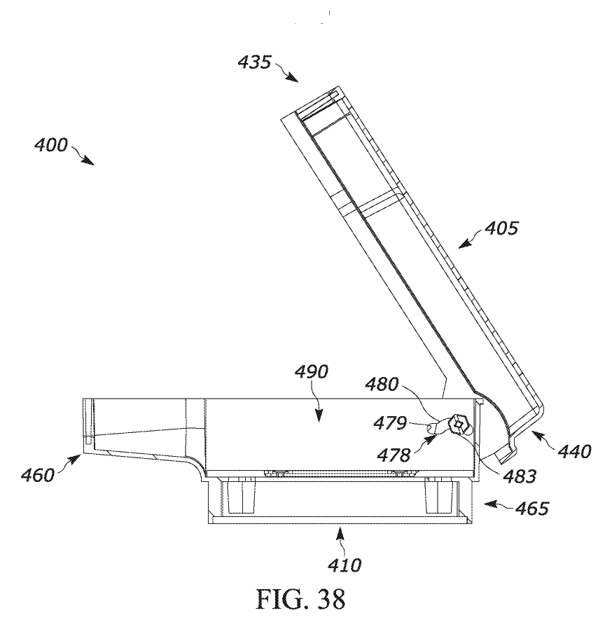

As shown in FIGS. 37 and 38, the lid 405 may pivot relative to the base 410 about the projections 475. For example, the lid 405 may pivot in a clockwise direction as viewed in FIGS. 37 and 38 to expose the internal volume 490. The curved surface of the opening 450 may rotate along the curved surface of the projection 475. The translation between the lid 405 and the base 410 may create spacing between the slot 452 and the protrusion 477 so that the elements do not substantially interfere with the rotational movement of the lid 405.

As shown in FIG. 38, each pin 456 may travel along the respective channel 478 as the lid 405 pivots relative to the base 410. For example, each pin 456 may move along the second section 480 of the channel 478. The curved path of the channel 478 may correspond to the pivoting movement of the lid 405. In other words, the pin 456 may smoothly move along the second section 480 without substantial interference from the walls of the channel 478.

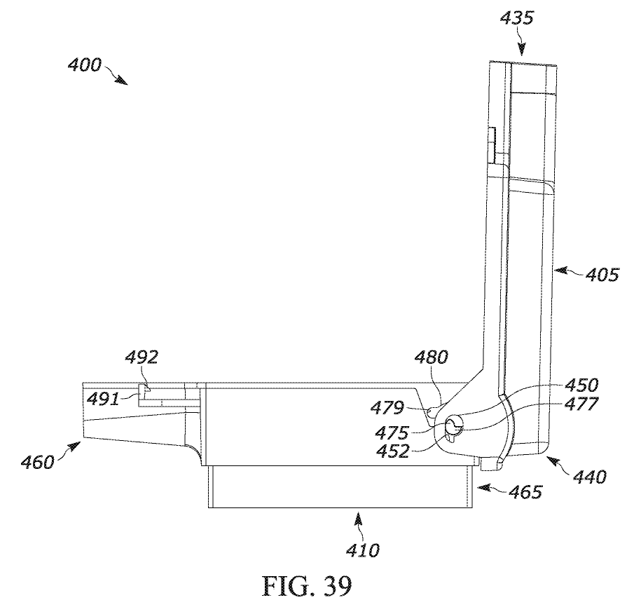

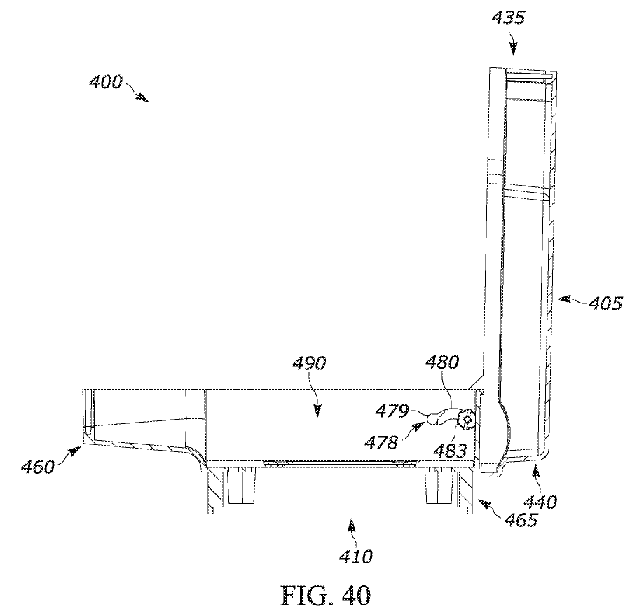

As shown in FIGS. 39 and 40, the lid 405 may be able to pivot at least 90 degrees relative to the closed position to provide full access to the internal volume 490. The lid 405 may be able to rest in the opened position (e.g., without assistance from user support), which may enable the user to interact with the electrical device within the internal volume 490 without needed to provide extra support to the lid 405 (e.g., the user may have both hands free).

As shown in FIG. 40, the pin 456 may be at the end of the second section 480 when the lid 405 is fully opened. The pin 456 may therefore act as a stop when contacting the end of the channel 478 to limit or prevent the lid 405 from over rotating relative to the base 410.

In some forms, the user may pivot the lid 405 (e.g., counterclockwise as viewed in FIGS. 39 and 40) so that it returns toward a closed position. Because the lid 405 initially moved away from the finger 491, the lid 405 may be able to pivot toward the closed position without contacting the overhang 492. In this way, the lid 405 may be able to pivot entirely to the closed position (e.g., the unlatched position of FIGS. 35 and 36) and would not get stuck on the overhang 492 (e.g., which may occur when the lid 405 does not engage the overhang 492 with enough force to cause the snap fit to engage). The user can then manually move the lid 405 from the unlatched position to the latched position to secure the lid 405 in the closed position.

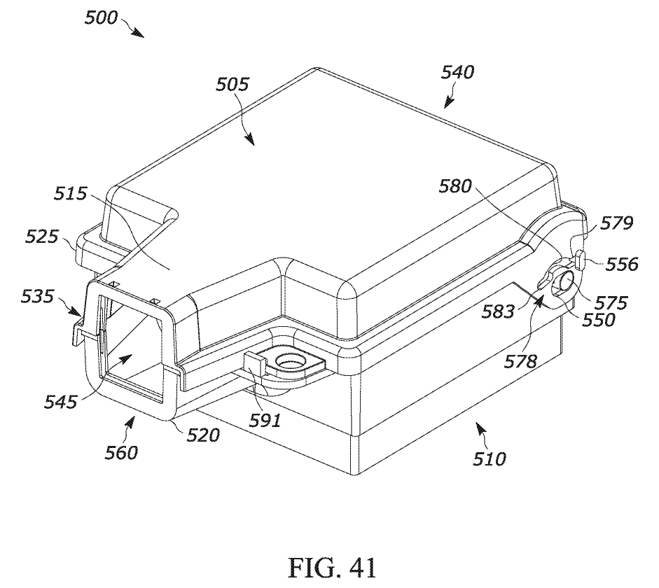

FIGS. 41-48 illustrate a fifth example of a cover 500. Only some similarities and differences between the cover 500 and the cover 100 may be described. Similar features include the same reference number plus “400”.

As shown in FIGS. 41-48, a while-in-use cover 500 may include a lid 505 coupled to a base 510. The lid 505 and the base 510 may have a substantially complementary shape, which may permit the lid 505 to interface with the base 510. In the illustrated example, the lid 505 and the base 510 may have a substantially rectangular shape, although the lid 505 and/or the base 510 may also include a different shape.

In certain forms, the lid 505 may include a neck 515 and the base 510 may include a complementary neck 520. Each neck 515, 520 may extend away from the generally rectangular shape. Each illustrated neck 515, 520 may have a tapered shape (e.g., with a free end being narrower). However, in other examples, the necks 515, 520 may include a constant width.

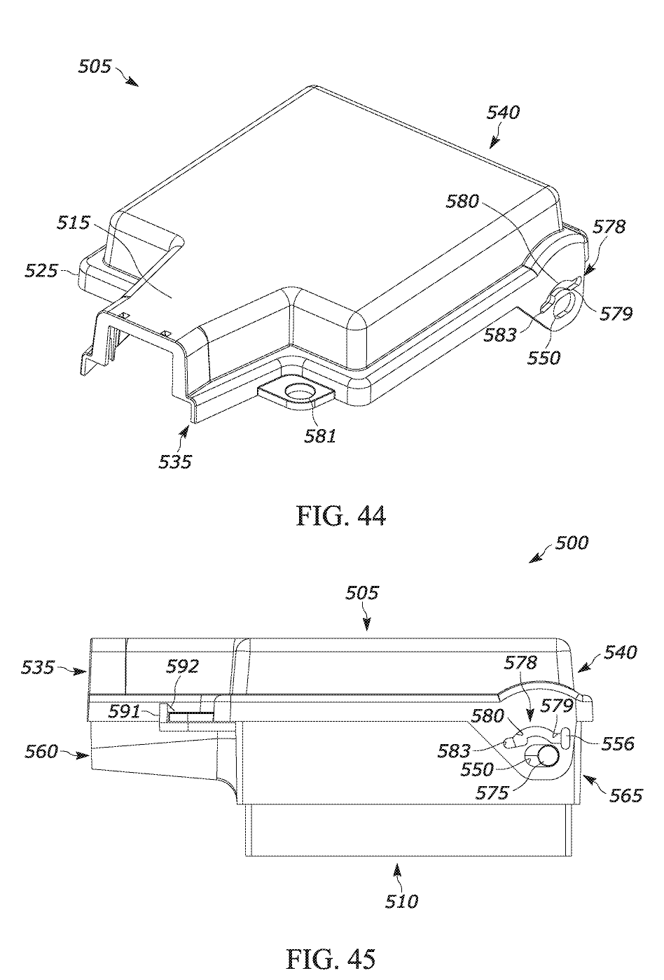

As shown in FIGS. 41 and 44, the lid 505 may include a lip 525 that extends at least partially around a perimeter of the lid 505. For example, the illustrated lip 525 may extend continuously around the perimeter of the lid 505, although in other examples, there may be one or more discontinuities in the lip 525.

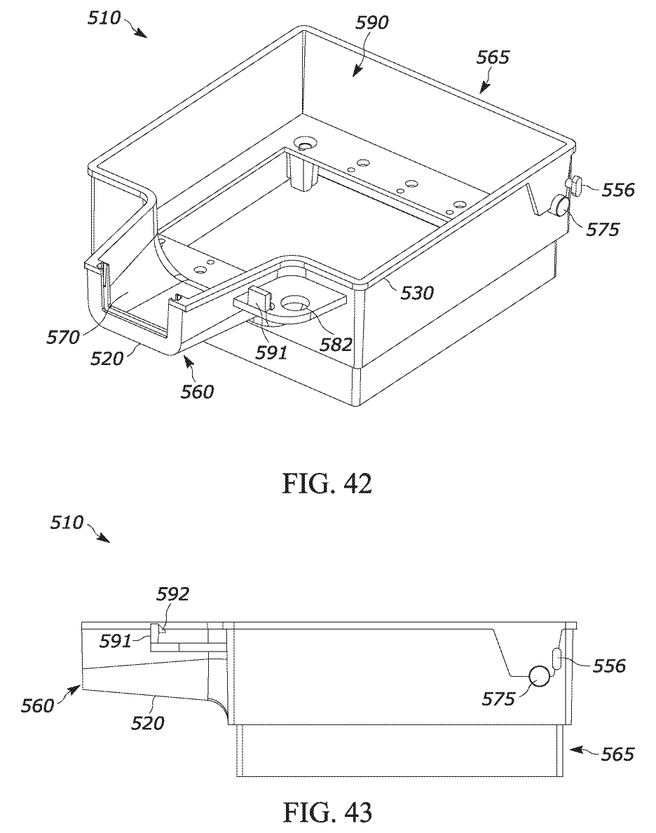

As shown in FIG. 42, the base 510 may include a flange 530 at an upper end. The flange 530 may have a complementary shape to the lip 525 and may be sized and shaped to permit the lip 525 to engage the flange 530. The illustrated example of the flange 530 may be substantially rectangular in shape and may extend outwardly from an outer surface of the base 510.

The lip 525 may have a greater width than a width of the base 510. This may permit the lid 505 to fit over the flange 530 of the base 510 and couple the lid 505 and the base 510 to one another. For example, the lip 525 may be sized to permit the lid 505 to selectively engage the flange 530 of the base 510 with a snap fit, although other types of connections may be used (e.g., a press fit, a friction fit, a magnetic connection, an adhesive, fasteners (e.g., threaded screws), swing arms etc.).

Returning to FIGS. 41 and 44, the lid 505 may include a first end 535 and a second end 540 opposite to the first end 535. The neck 515 may extend to the first end 535. As will be described in more detail below, the neck 515 may be hollow and may include an opening 545 at the first end 535.

Side walls proximate to the second end 540 may include a first hinge portion 550 that may assist in connecting the lid 505 to the base 510. In the illustrated example, the first hinge portion 550 may include a pair of discrete openings spaced apart from one another on opposite walls of the lid 505. Each opening of the first hinge portion 550 may be at least partially rounded in shape.

As shown in FIG. 44, each first hinge portion opening 550 may have an elongated shape that extends in a direction between the first and second ends 535, 540. Each opening 550 may have a partially oval or pill shape.

With continued reference to FIG. 44, a channel 578 may be disposed on a side wall of the lid 505 proximate to each opening 550. For example, each channel 578 may be disposed above the respective projection 575 (e.g., more proximate to an opening to the internal volume 590). In the illustrated example, the channel 578 may include a first section 579, a second section 580, and a third section 583. The first and third sections 579, 583 may be oriented substantially parallel to the direction between the first and second ends 535, 540 of the lid 505. The second section 580 may extend between the first and third sections 579, 583 and may follow a curved path. The channel 578 may be spaced apart from the opening 550 so that the channel 578 has a fully defined perimeter.

The base 510 may similarly include a first end 560 and a second end 565. The neck 520 may extend to the first end 560. As will be described in more detail below, the neck 520 may be hollow and may include an opening 570 at the first end 560. In some forms, one or more blocking portions may be positioned in the necks 515, 520 to further prevent the ingress of fluids.

A second hinge portion 575 may be formed proximate to the second end 565 and may assist in connecting the lid 505 to the base 510. As shown in FIGS. 42 and 43, the second hinge portion 575 may include projections with a similar size as the first hinge portion 550. In other examples, one or more of the openings 550 may be disposed on the base 510 and one or more of the projections 575 may be disposed on the lid 505.

As shown in FIG. 43, each projection 575 may extend from a wall of the base 510 in a direction substantially perpendicular to the direction that extends between the first and second ends 560, 565. Each illustrated projection 575 may also have substantially circular shape. For example, each projection 575 may have substantially the same radius of curvature as the ends of the openings 550.

With continued reference to FIG. 43, a pin 556 may extend from either side wall of the base 510 proximate to the respective projection 575. Each pin 556 may be formed with a first portion 557 that is substantially cylindrical and extends directly from the surface of the base 510. A second portion 558 may be coupled to the first portion 557 and may have an elongated shape (e.g., an oval or pill shape similar to the shape of the opening 550). Each second portion 558 may extend along a major axis running in the direction between the top and bottom of the base 510 (e.g., in a direction perpendicular to the direction between the first and second ends 560, 565).

As shown in FIG. 42, the base 510 may include an internal volume 590 that may be at least partially enclosed by the lid 505 (e.g., in the closed position of FIG. 41). The internal volume 590 may at least partially support an electrical device. In some examples, an extension ring may be coupled to the base 510 and provide an additional volume to house the electrical device. The extension ring may be removably coupled to the base 510 or may be integrally formed with the base 510.

The lid 505 may be connected to the base 510 by aligning the openings 550 with the projections 575. For example, when the first end 535 of the lid 505 is disposed proximate to the first end 560 of the base 510, the shape of each projection 575 may align with the shape of the respective opening 550.

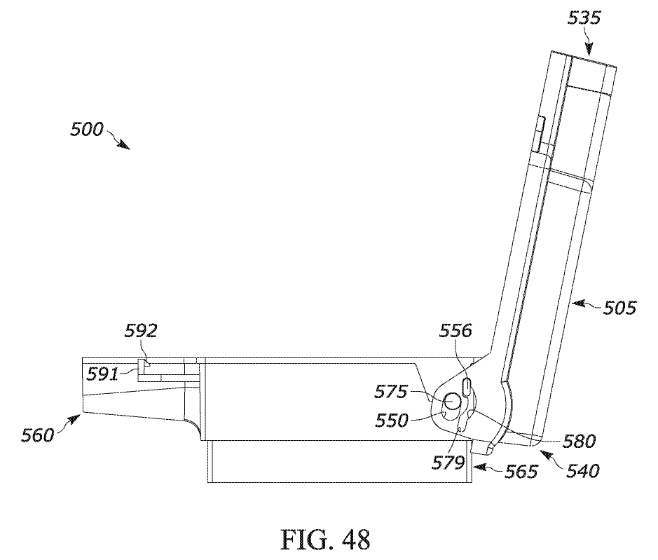

Additionally, the second portion 558 of the pin 556 may be inserted into the channel 578. For example, the lid 505 may be oriented substantially perpendicularly with respect to the base 510 (see e.g., FIG. 48) so that the third section 583 is oriented in the same direction as the second portion 558. This may allow the second portion 558 to fit through the width of the channel 578. The first portion 557 may have a width that is less than the width of the channel 578, so that once the second portion 578 is through the channel 578, the first portion 557 can move along the channel 578 and the second portion 558 may limit the disconnection of the lid 505 from the base 510.

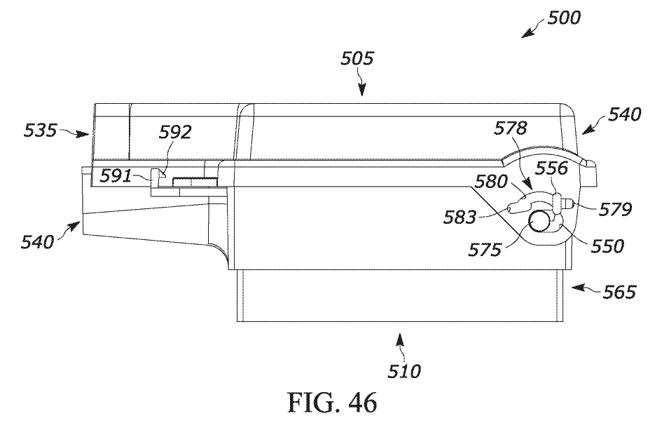

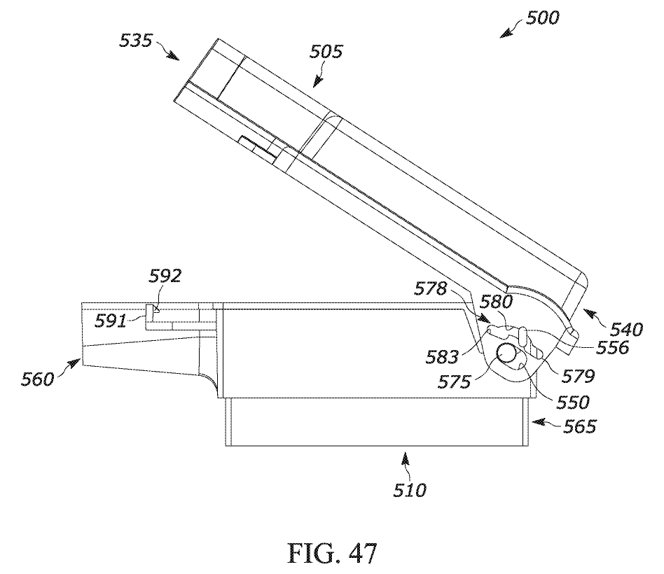

The lid 505 is selectively movable relative to the base 510 between a closed, latched position (see e.g., FIGS. 45 and 46) and an open position (see e.g., FIG. 47 and 48). In the closed position, the lid 505 may be secured to the base 510 and may limit the ingress of fluids into a volume of the cover 500. A snap-fit (or other similar connection) may selectively secure the lid 505 to the base 510 and limit the lid 505 from pivoting relative to the base. For example, the base 510 may include a finger 591, which may be formed as a cantilever member with an overhang 592 proximate to the free end (see e.g., FIG. 3). The lid 505 may engage the finger 591 with a snap fit so that in the closed position, the overhang 592 may limit the rotational movement of the lid 505 relative to the base 510.

In some forms, the lid 505 may also include a first locking aperture 581 that may align with a second locking aperture 582 of the base 510 when the lid 505 is in the closed position. A padlock (or other locking mechanism – not shown) may connect to the cover 500 through the first and second locking apertures 581, 582. This may limit unauthorized movement of the lid 505 relative to the base 510.

As shown in FIG. 46, the lid 505 may move to an unlatched position where the first end 535 of the lid 505 is disengaged from the overhang 592. For example, the elongated shape of the opening 550 is larger than the size of the projection 575. In other words, the size of the opening 550 may permit the lid 505 to translate relative to the base 510. A user may translate the lid 505 so that the first end 535 of the lid 505 moves away from the first end 560 of the base 510 and toward the second end 565. As the lid 505 translates, the first end 535 of the lid 505 moves beyond the end of the overhang 592. Simultaneously, the second portion 558 of the pin 556 moves along the first section 579 of the channel 578. A user may continue to translate the lid 505 until the pin 556 reaches the end of the first section 579 and a transition between the first and second sections 579, 580. In this position, the overhang 592 may not limit the rotational movement of the lid 505. The lid 505 may still be considered in a closed position (despite not being latched to the base 510) because it still limits access to the internal volume 590.

As shown in FIGS. 47 and 48, the lid 505 may pivot relative to the base 510 about the projections 575. For example, the lid 505 may pivot in a clockwise direction as viewed in FIGS. 47 and 48 to expose the internal volume 590. The curved surface of the opening 550 may rotate along the curved surface of the projection 575.

As the lid 505 pivots, the first portion 557 of the pin 556 may move along the second section 580 of the channel 578. For example, the curved shape of the second section 580 may permit the rotational movement of the lid 505. In some forms, the lid 505 may be able to pivot at least 90 degrees relative to the closed position to provide full access to the internal volume 590. The lid 505 may be able to rest in the opened position (e.g., without assistance from user support), which may enable the user to interact with the electrical device within the internal volume 590 without needed to provide extra support to the lid 505 (e.g., the user may have both hands free). For example, the pin 556 may move into the third section 583 of the channel 578 (see e.g., FIG. 48), which may retain the lid 505 in the opened position.

In some forms, the user may pivot the lid 505 (e.g., counterclockwise as viewed in FIG. 48) so that it returns toward a closed position. Because the lid 505 initially moved away from the finger 591, the lid 505 may be able to pivot toward the closed position without contacting the overhang 592. In this way, the lid 505 may be able to pivot entirely to the closed position (e.g., the unlatched position of FIG. 46) and would not get stuck on the overhang 592 (e.g., which may occur when the lid 505 does not engage the overhang 592 with enough force to cause the snap fit to engage). The user can then manually move the lid 505 from the unlatched position to the latched position to secure the lid 505 in the closed position.

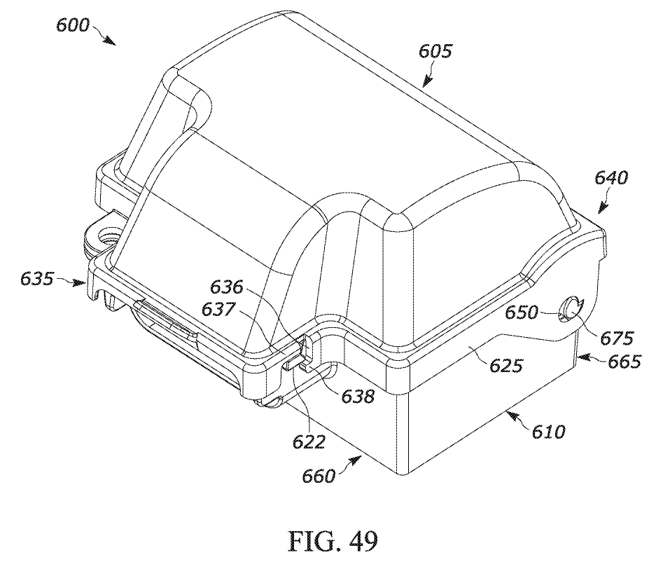

FIGS. 49-55 illustrate a sixth example of a cover 600. Only some similarities and differences between the cover 600 and the cover 100 may be described. Similar features include the same reference number plus “500”.

As shown in FIGS. 49-55, a while-in-use cover 600 may include a lid 605 coupled to a base 610. The lid 605 and the base 610 may have a substantially complementary shape, which may permit the lid 605 to interface with the base 610. In the illustrated example, the lid 605 and the base 610 may have a substantially rectangular shape, although the lid 605 and/or the base 610 may also include a different shape.

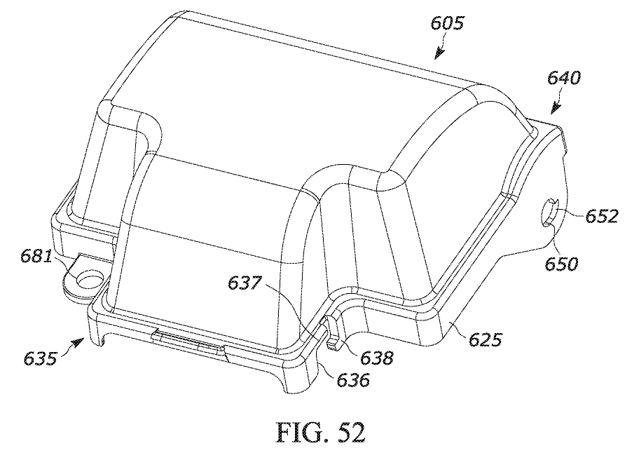

As shown in FIGS. 49 and 52, a first end 635 of the lid 605 may include a groove 636 formed along either side wall. For example, the groove 636 may be open to the lower edge of the lid 605 and may include an overhang 637 and an undercut 638.

With continued reference to FIGS. 49 and 52, the lid 605 may include a lip 625 that extends at least partially around a perimeter of the lid 605. For example, the illustrated lip 625 may extend continuously around the perimeter of the lid 605, although in other examples, there may be one or more discontinuities in the lip 625.

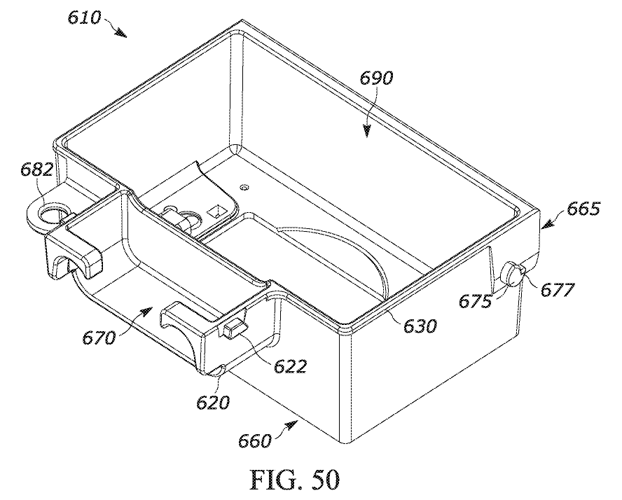

As shown in FIG. 50, the base 610 may include a flange 630 at an upper end. The flange 630 may have a complementary shape to the lip 625 and may be sized and shaped to permit the lip 625 to engage the flange 630. The illustrated example of the flange 630 may be substantially rectangular in shape and may extend outwardly from an outer surface of the base 610.

The lip 625 may have a greater width than a width of the base 610. This may permit the lid 605 to fit over the flange 630 of the base 610 and couple the lid 605 and the base 610 to one another. For example, the lip 625 may be sized to permit the lid 605 to selectively engage the flange 630 of the base 610 with a snap fit, although other types of connections may be used (e.g., a press fit, a friction fit, a magnetic connection, an adhesive, fasteners (e.g., threaded screws), swing arms etc.).

Side walls proximate to a second end 640 may include a first hinge portion 650 that may assist in connecting the lid 605 to the base 610. In the illustrated example, the first hinge portion 650 may include a pair of discrete openings spaced apart from one another on opposite walls of the lid 605. Each opening of the first hinge portion 650 may be at least partially rounded in shape.

In some forms, each first hinge portion opening 650 may have an elongated shape that extends in a direction between the first and second ends 635, 640. Each opening 650 may have a partially oval or pill shape. For example, one end of the opening 650 proximate to the first end 635 may be substantially semi-circular in shape. The opposite end of the opening 650 proximate to the second end 640 may have a substantially quarter circular shape, which forms a slot 652. A solid portion of the lid 605 may be adjacent to the quarter-circular portion of the opening 150 (also in a substantially quarter circle shape) so that the ends of the opening 650 are not symmetrical.

The base 610 may similarly include a first end 660 and a second end 665. A neck 620 may extend to the first end 660. The neck 620 may be hollow and may include an opening 670 at the first end 660. In some forms, one or more blocking portions may be positioned in the necks 620 to further prevent the ingress of fluids.

In certain forms, a latching projection 622 may be extend from either side of the neck 620. The illustrated latching projection 622 may have a substantially trapezoidal shape, although other examples of the latching projection 622 may have different shapes.

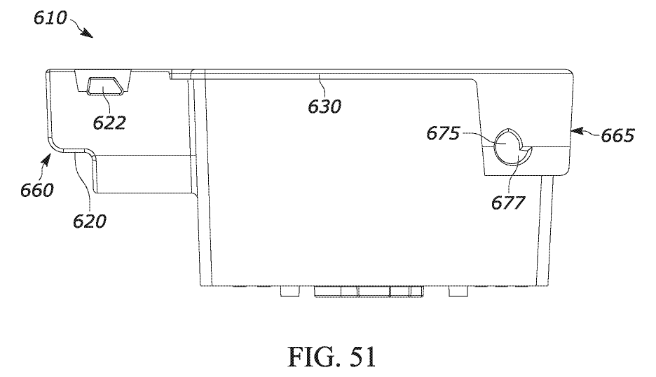

A second hinge portion 675 may be formed proximate to the second end 665 and may assist in connecting the lid 605 to the base 610. As shown in FIGS. 50 and 51, the second hinge portion 675 may include projections with a similar size as the first hinge portion 650. In other examples, one or more of the openings 650 may be disposed on the base 610 and one or more of the projections 675 may be disposed on the lid 605.

As shown in FIG. 51, each projection 675 may extend from a wall of the base 610 in a direction substantially perpendicular to the direction that extends between the first and second ends 660, 665. Each illustrated projection 675 may also have an at least partially circular shape. For example, each projection 675 may have a substantially three-quarters circle shape, which may be similar to the shape of the opening 650. In other words, the projection 675 may have a semi-circular shape with a protrusion 677 (e.g., having a substantially quarter-circular shape) that has a similar size and shape as the slot 652.

As shown in FIG. 50, the base 610 may include an internal volume 690 that may be at least partially enclosed by the lid 605 (e.g., in the closed position of FIG. 49). The internal volume 690 may at least partially support an electrical device. In some examples, an extension ring may be coupled to the base 610 and provide an additional volume to house the electrical device. The extension ring may be removably coupled to the base 610 or may be integrally formed with the base 610.

The lid 605 may be connected to the base 610 by aligning the openings 650 with the projections 675. For example, when the first end 635 of the lid 605 is disposed proximate to the first end 660 of the base 610, the shape of each projection 675 may align with the shape of the respective opening 650 so that the protrusion 677 is at least partially received within the slot 652.

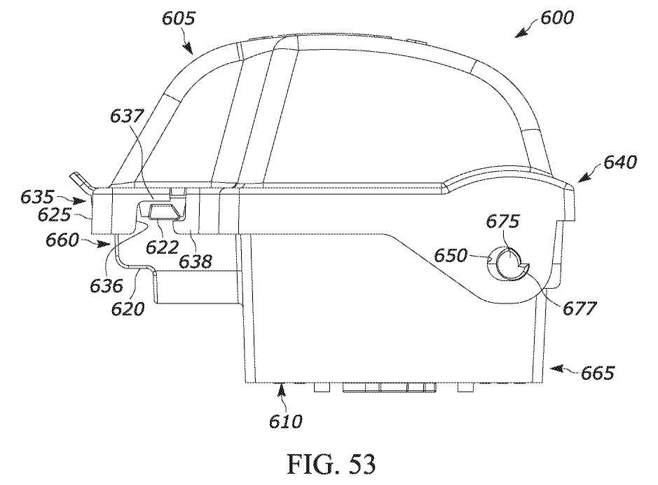

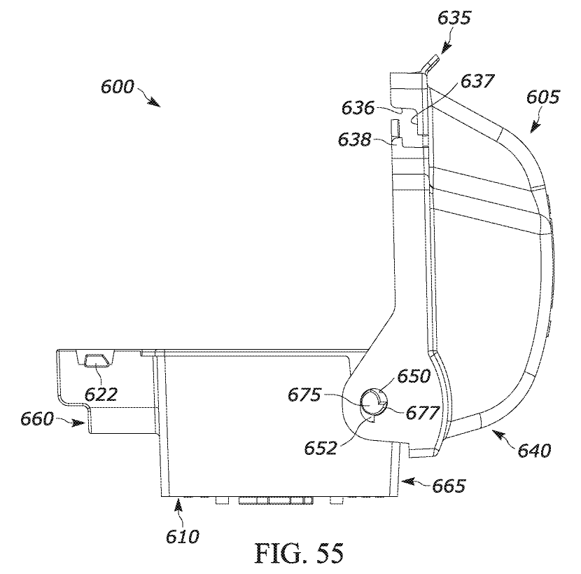

The lid 605 is selectively movable relative to the base 610 between a closed, latched position (see e.g., FIGS. 49 and 53) and an open position (see e.g., FIG. 55). In the closed position, the lid 605 may be secured to the base 610 and may limit the ingress of fluids into a volume of the cover 600. The latching projection 622 may selectively secure the lid 605 to the base 610 and limit the lid 605 from pivoting relative to the base. For example, the latching projection 622 may be received within the groove 636 of the lid 605. The undercut 638 may extend below the latching projection 622 to limit the rotation of the lid 605 relative to the base 610.

In some forms, the lid 605 may also include a first locking aperture 681 that may align with a second locking aperture 682 of the base 610 when the lid 605 is in the closed position. A padlock (or other locking mechanism – not shown) may connect to the cover 600 through the first and second locking apertures 681, 682. This may limit unauthorized movement of the lid 605 relative to the base 610.

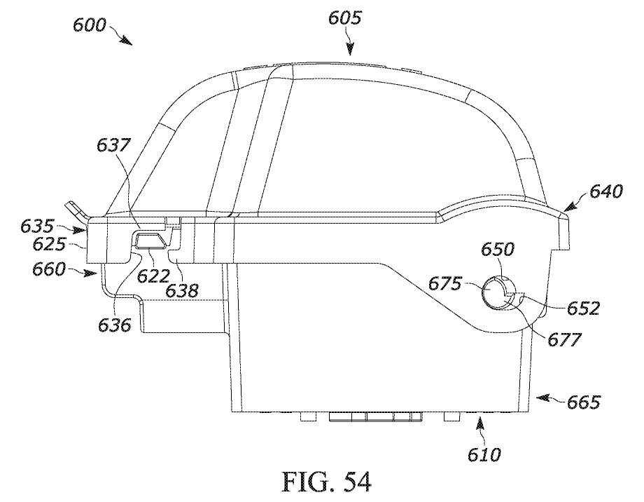

As shown in FIG. 54, the lid 605 may move to an unlatched position where the first end 635 of the undercut 638 is spaced apart from the latching projection 622. For example, the elongated shape of the opening 650 is larger than the size of the projection 675. In other words, the size of the opening 650 may permit the lid 605 to translate relative to the base 610. A user may translate the lid 605 so that the first end 635 of the lid 605 moves away from the first end 660 of the base 610 and toward the second end 665. As the lid 605 translates, the latching projection 622 of the base 610 moves beyond the end of the undercut 638. Simultaneously, the projection 675 moves along the opening so that the protrusion 677 moves out of the slot 652. A user may continue to translate the lid 605 until the protrusion 677 has completely exited the slot 652. In this position, neither the undercut 638 nor the protrusion 677 may limit the rotational movement of the lid 605. The lid 605 may still be considered in a closed position (despite not being latched to the base 610) because it still limits access to the internal volume 690.

As shown in FIG. 55, the lid 605 may pivot relative to the base 610 about the projections 675. For example, the lid 605 may pivot in a clockwise direction as viewed in FIG. 55 to expose the internal volume 690. The curved surface of the opening 650 may rotate along the curved surface of the projection 675. The translation between the lid 605 and the base 610 may create spacing between the slot 652 and the protrusion 677 so that the elements do not substantially interfere with the rotational movement of the lid 605.

In some forms, the lid 605 may be able to pivot at least 90 degrees relative to the closed position to provide full access to the internal volume 690. The lid 605 may be able to rest in the opened position (e.g., without assistance from user support), which may enable the user to interact with the electrical device within the internal volume 690 without needed to provide extra support to the lid 605 (e.g., the user may have both hands free).

In some forms, the user may pivot the lid 605 (e.g., counterclockwise as viewed in FIG. 55) so that it returns toward a closed position. Because the lid 605 initially moved away from the undercut 638, the lid 605 may be able to pivot toward the closed position without contacting the undercut 638. In this way, the lid 605 may be able to pivot entirely to the closed position (e.g., the unlatched position of FIG. 54) and would not get stuck on the undercut 638 (e.g., which may occur when the lid 605 does not engage the undercut 638 with enough force to cause the snap fit to engage). The user can then manually move the lid 605 from the unlatched position to the latched position to secure the lid 605 in the closed position.

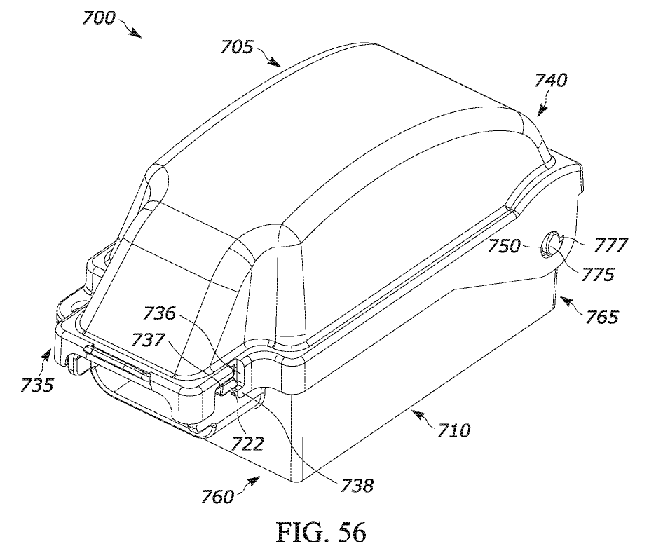

FIGS. 56-62 illustrate a seventh example of a cover 700. Only some similarities and differences between the cover 700 and the cover 600 may be described. Similar features include the same reference number plus “100”.

As shown in FIGS. 56-62, a while-in-use cover 700 may include a lid 705 coupled to a base 710. The lid 705 and the base 710 may have a substantially complementary shape, which may permit the lid 705 to interface with the base 710. In the illustrated example, the lid 705 and the base 710 may have a substantially rectangular shape, although the lid 705 and/or the base 710 may also include a different shape. In the illustrated example, the cover 700 may have a narrower shape as compared to the cover 600.

As shown in FIG. 56, a first end 735 of the lid 705 may include a groove 736 formed along a side wall. For example, the groove 736 may be open to the lower edge of the lid 705 and may include an overhang 737 and an undercut 738.

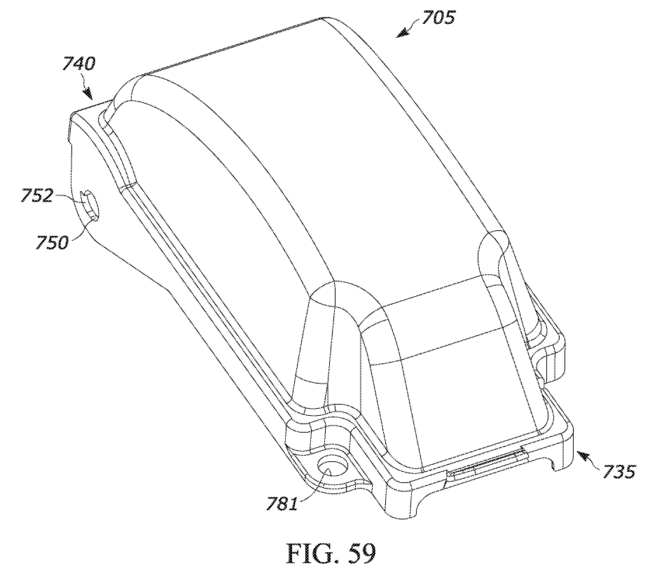

With continued reference to FIGS. 56 and 59, the lid 705 may include a lip 725 that extends at least partially around a perimeter of the lid 705. For example, the illustrated lip 725 may extend continuously around the perimeter of the lid 705, although in other examples, there may be one or more discontinuities in the lip 725.

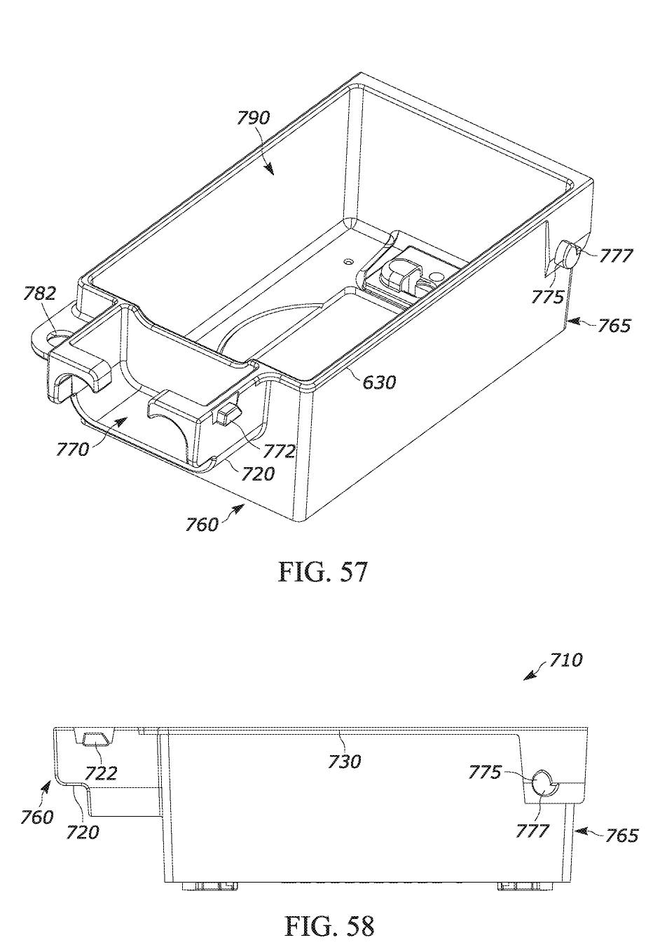

As shown in FIG. 57, the base 710 may include a flange 730 at an upper end. The flange 6730 may have a complementary shape to the lip 725 and may be sized and shaped to permit the lip 725 to engage the flange 730. The illustrated example of the flange 730 may be substantially rectangular in shape and may extend outwardly from an outer surface of the base 710.

The lip 725 may have a greater width than a width of the base 710. This may permit the lid 705 to fit over the flange 730 of the base 710 and couple the lid 705 and the base 710 to one another. For example, the lip 725 may be sized to permit the lid 705 to selectively engage the flange 730 of the base 710 with a snap fit, although other types of connections may be used (e.g., a press fit, a friction fit, a magnetic connection, an adhesive, fasteners (e.g., threaded screws), swing arms etc.).

Side walls proximate to a second end 740 may include a first hinge portion 750 that may assist in connecting the lid 705 to the base 710. In the illustrated example, the first hinge portion 750 may include a pair of discrete openings spaced apart from one another on opposite walls of the lid 705. Each opening of the first hinge portion 750 may be at least partially rounded in shape.

In some forms, each first hinge portion opening 750 may have an elongated shape that extends in a direction between the first and second ends 735, 740. Each opening 750 may have a partially oval or pill shape. For example, one end of the opening 750 proximate to the first end 735 may be substantially semi-circular in shape. The opposite end of the opening 750 proximate to the second end 740 may have a substantially quarter circular shape, which forms a slot 752. A solid portion of the lid 705 may be adjacent to the quarter-circular portion of the opening 750 (also in a substantially quarter circle shape) so that the ends of the opening 750 are not symmetrical.

The base 710 may similarly include a first end 760 and a second end 765. A neck 720 may extend to the first end 760. The neck 720 may be hollow and may include an opening 770 at the first end 760. In some forms, one or more blocking portions may be positioned in the necks 720 to further prevent the ingress of fluids.

In certain forms, a latching projection 722 may be extend from one side of the neck 720. The illustrated latching projection 722 may have a substantially trapezoidal shape, although other examples of the latching projection 722 may have different shapes.

A second hinge portion 775 may be formed proximate to the second end 765 and may assist in connecting the lid 705 to the base 710. As shown in FIGS. 57 and 58, the second hinge portion 775 may include projections with a similar size as the first hinge portion 750. In other examples, one or more of the openings 750 may be disposed on the base 710 and one or more of the projections 775 may be disposed on the lid 705.

As shown in FIG. 58, each projection 775 may extend from a wall of the base 710 in a direction substantially perpendicular to the direction that extends between the first and second ends 760, 765. Each illustrated projection 775 may also have an at least partially circular shape. For example, each projection 775 may have a substantially three-quarters circle shape, which may be similar to the shape of the opening 750. In other words, the projection 775 may have a semi-circular shape with a protrusion 777 (e.g., having a substantially quarter-circular shape) that has a similar size and shape as the slot 752.

As shown in FIG. 57, the base 710 may include an internal volume 790 that may be at least partially enclosed by the lid 705 (e.g., in the closed position of FIG. 56). The internal volume 790 may at least partially support an electrical device. In some examples, an extension ring may be coupled to the base 710 and provide an additional volume to house the electrical device. The extension ring may be removably coupled to the base 710 or may be integrally formed with the base 710.

The lid 705 may be connected to the base 710 by aligning the openings 750 with the projections 775. For example, when the first end 735 of the lid 705 is disposed proximate to the first end 760 of the base 710, the shape of each projection 775 may align with the shape of the respective opening 750 so that the protrusion 777 is at least partially received within the slot 752.

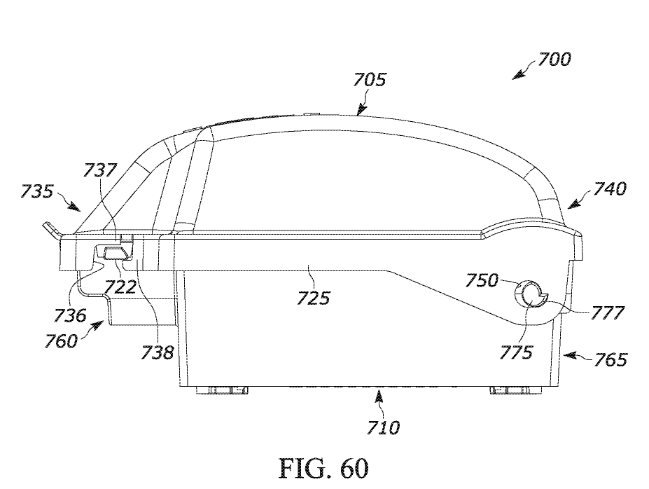

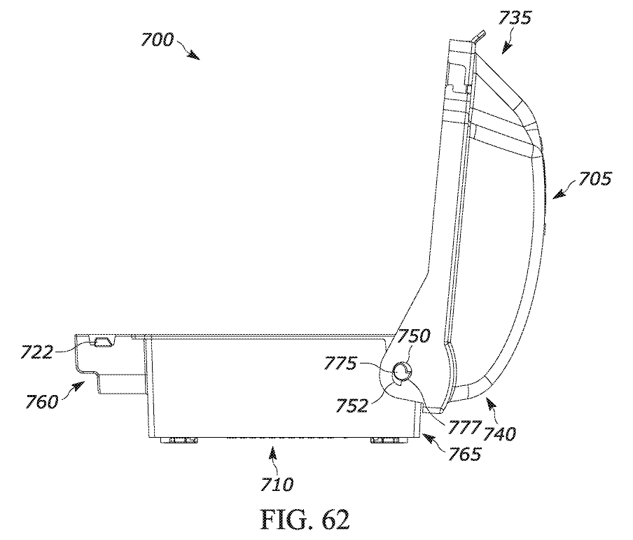

The lid 705 is selectively movable relative to the base 710 between a closed, latched position (see e.g., FIGS. 56 and 60) and an open position (see e.g., FIG. 62). In the closed position, the lid 705 may be secured to the base 710 and may limit the ingress of fluids into a volume of the cover 700. The latching projection 722 may selectively secure the lid 705 to the base 710 and limit the lid 705 from pivoting relative to the base. For example, the latching projection 722 may be received within the groove 736 of the lid 705. The undercut 738 may extend below the latching projection 722 to limit the rotation of the lid 705 relative to the base 710.

In some forms, the lid 705 may also include a first locking aperture 781 that may align with a second locking aperture 782 of the base 710 when the lid 705 is in the closed position. A padlock (or other locking mechanism – not shown) may connect to the cover 700 through the first and second locking apertures 781, 782. This may limit unauthorized movement of the lid 705 relative to the base 710.

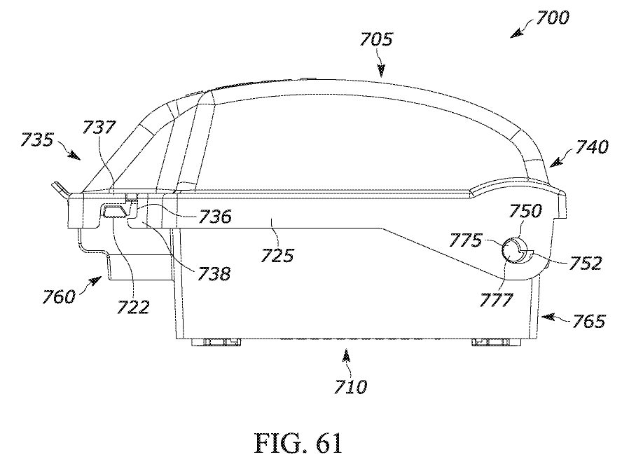

As shown in FIG. 61, the lid 705 may move to an unlatched position where the first end 735 of the undercut 738 is spaced apart from the latching projection 722. For example, the elongated shape of the opening 750 is larger than the size of the projection 775. In other words, the size of the opening 750 may permit the lid 705 to translate relative to the base 710. A user may translate the lid 705 so that the first end 735 of the lid 705 moves away from the first end 760 of the base 710 and toward the second end 765. As the lid 705 translates, the latching projection 722 of the base 710 moves beyond the end of the undercut 738. Simultaneously, the projection 775 moves along the opening so that the protrusion 777 moves out of the slot 752. A user may continue to translate the lid 705 until the protrusion 777 has completely exited the slot 752. In this position, neither the undercut 738 nor the protrusion 777 may limit the rotational movement of the lid 705. The lid 705 may still be considered in a closed position (despite not being latched to the base 710) because it still limits access to the internal volume 790.

As shown in FIG. 62, the lid 705 may pivot relative to the base 710 about the projections 775. For example, the lid 705 may pivot in a clockwise direction as viewed in FIG. 62 to expose the internal volume 790. The curved surface of the opening 750 may rotate along the curved surface of the projection 775. The translation between the lid 705 and the base 710 may create spacing between the slot 752 and the protrusion 777 so that the elements do not substantially interfere with the rotational movement of the lid 705.

In some forms, the lid 705 may be able to pivot at least 90 degrees relative to the closed position to provide full access to the internal volume 790. The lid 705 may be able to rest in the opened position (e.g., without assistance from user support), which may enable the user to interact with the electrical device within the internal volume 790 without needed to provide extra support to the lid 705 (e.g., the user may have both hands free).

In some forms, the user may pivot the lid 705 (e.g., counterclockwise as viewed in FIG. 62) so that it returns toward a closed position. Because the lid 705 initially moved away from the undercut 738, the lid 705 may be able to pivot toward the closed position without contacting the undercut 738. In this way, the lid 705 may be able to pivot entirely to the closed position (e.g., the unlatched position of FIG. 61) and would not get stuck on the undercut 738 (e.g., which may occur when the lid 705 does not engage the undercut 738 with enough force to cause the snap fit to engage). The user can then manually move the lid 705 from the unlatched position to the latched position to secure the lid 705 in the closed position.

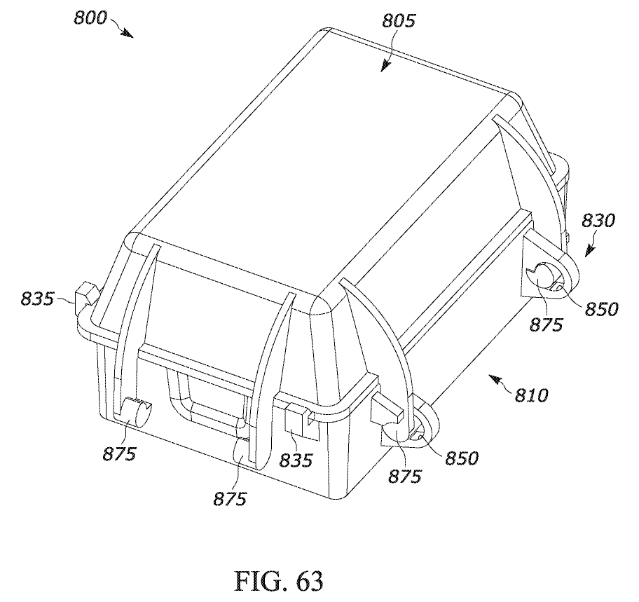

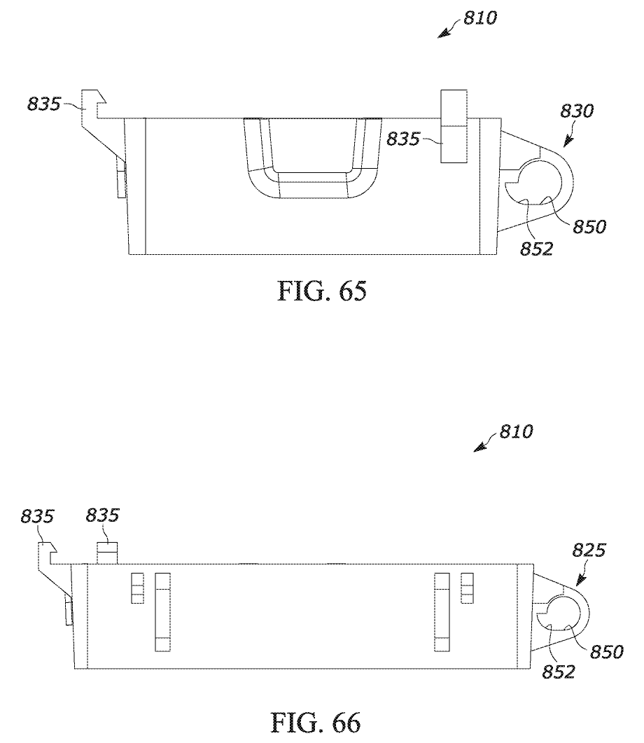

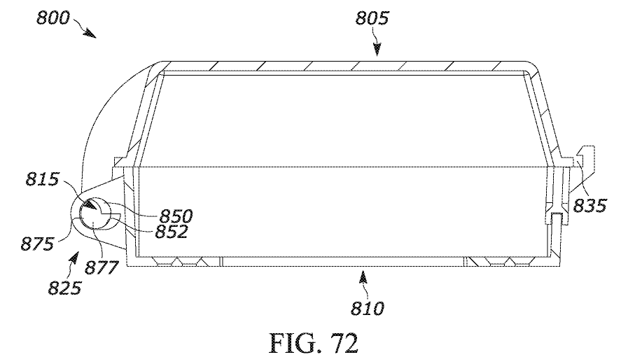

FIGS. 63-73 illustrate an eighth example of a cover 800. Only some similarities and differences between the cover 800 and the cover 100 may be described. The illustrated cover 800 may include a lid 805 and a base 810. The lid 805 may be movable relative to the base 810 and selectively securable to the base 810. For example, the lid 805 may be pivotable relative to the base 810, although other types of movement (e.g., translating) may be used.

In some forms, the lid 805 may include a first connecting region 815 and a second connecting region 820 disposed on a different edge of the lid 805 than the first connecting region 815. For example, the first connecting region 815 and the second connecting region 820 may be on perpendicular edges. As described in more detail below, either the first connecting region 815 or the second connecting region 820 may be used to connect the lid 805 to the base 810. In certain forms, the first and second connecting regions 815, 820 may each be projections that are received in openings on the base 810.

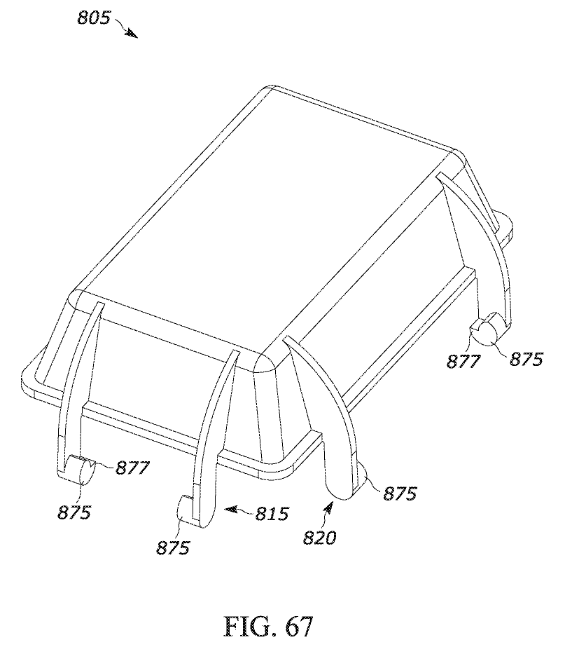

As shown in FIG. 67, the first and second connecting regions 815, 820 of the lid 805 may include projections 875. Each projection 875 may have an at least partially circular shape. For example, each projection 875 may have a substantially three-quarters circle shape. In other words, the projection 875 may have a semi-circular shape with a protrusion 877 (e.g., having a substantially quarter-circular shape) that has a similar size.

In some forms, the base 810 may include a first connecting region 825 and a second connecting region 830 disposed on a different edge of the base 810 than the first connecting region 825. For example, the first connecting region 825 and the second connecting region 830 may be on perpendicular edges. In certain forms, the first and second connecting regions 825, 830 of the base 810 may be openings that can receive the projections 875 of the connecting regions 815, 820 on the lid 805.

In some forms, each first and second connecting region 825, 830 of the base 810 may include an opening 850 may have an elongated shape. In other examples, one or more of the openings 850 may be disposed on the lid 805 and one or more of the projections 875 may be disposed on the base 810.

Each opening 850 may have a partially oval or pill shape. For example, one end of the opening 850 may be substantially semi-circular in shape. The opposite end of the opening 850 may have a substantially quarter circular shape, which forms a slot 852. A solid portion of the base 810 may be adjacent to the quarter-circular portion of the opening 850 (also in a substantially quarter circle shape) so that the ends of the opening 850 are not symmetrical.

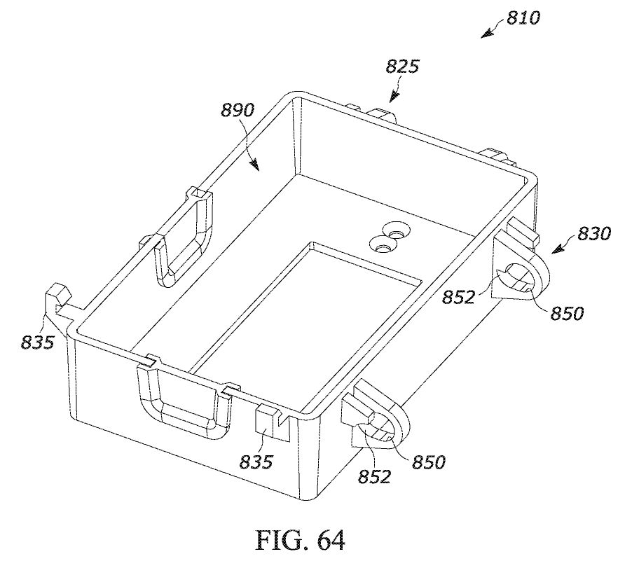

As shown in FIG. 64, the base 810 may include an internal volume 890 that may be at least partially enclosed by the lid 805 (e.g., in the closed position of FIG. 63). The internal volume 890 may at least partially support an electrical device. In some examples, an extension ring may be coupled to the base 810 and provide an additional volume to house the electrical device. The extension ring may be removably coupled to the base 810 or may be integrally formed with the base 810.

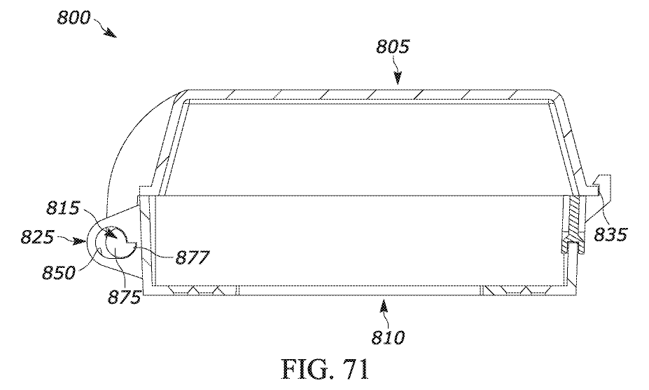

In certain forms, the connecting regions 815, 820 of the lid 805 may be on different edges than the connecting regions 825, 830 of the base 810. For example, as illustrated in FIGS. 71-73, the lid 805 may be positioned so that the first connecting region 815 of the lid 805 is proximate to the first connecting region 825 of the base 810. However, the second connecting region 820 of the lid 805 is positioned opposite to the second connecting region 830 of the base 810. In this position, the first connecting regions 815, 825 are connected together and the lid 805 is permitted to pivot relative to the base 810 along a first axis.

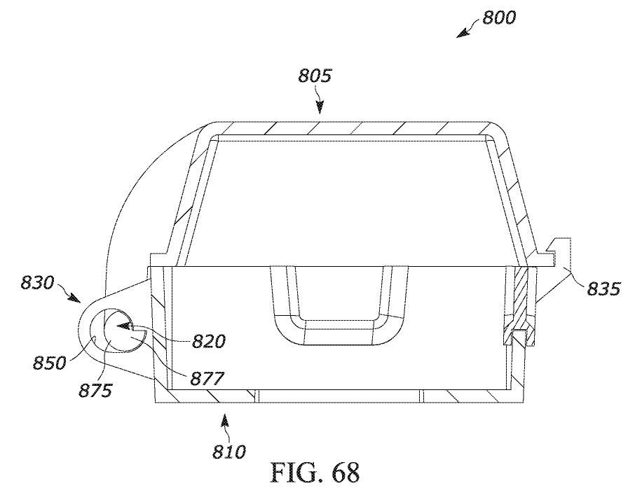

In another form, the lid 805 could be re-oriented (e.g., pivoted 180 degrees) so that the second connecting region 820 of the lid 805 is proximate to the second connecting region 830 of the base 810, and the first connecting region 815 of the lid 805 is positioned opposite to the first connecting region 825 of the base 810. In this position, the second connecting regions 820, 830 are connected together (see e.g., FIGS. 68-70) and the lid 805 is permitted to pivot relative to the base 810 along a second axis that is substantially perpendicular to the first axis. This permits the user to select the orientation of the lid 805 relative to the base 810 so that the lid 805 can move in different directions depending on space constraints, personal preference, etc. A similar lid connection is disclosed in U.S. Patent No. 7,439,444, which is disclosed herein by reference in its entirety.

The lid 805 may be connected to the base 810 by aligning the openings 850 with the projections 875. For example, when the selected first or second connecting region 815, 820 of the lid 805 is positioned proximate to the corresponding connecting region 825, 830 of the base 810, the shape of each projection 875 may align with the shape of the respective opening 850 so that the protrusion 877 is at least partially received within the slot 852.

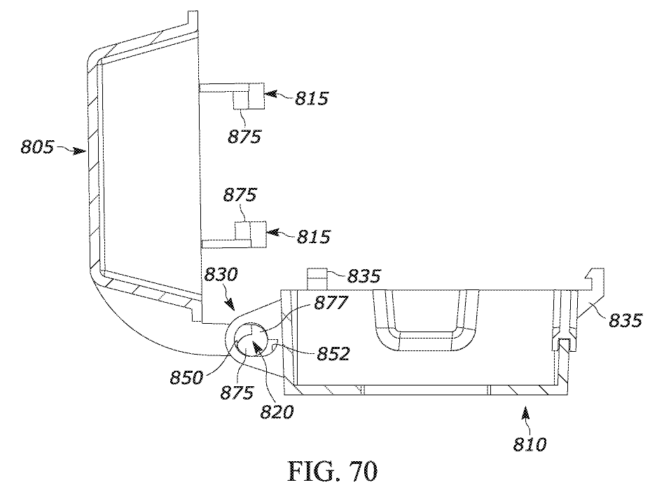

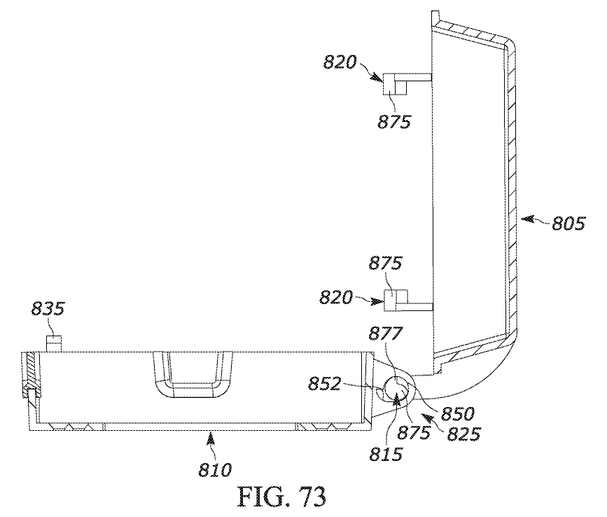

The lid 805 is selectively movable relative to the base 810 between a closed, latched position (see e.g., FIGS. 63, 68, and 71, ) and an open position (see e.g., FIGS. 70 and 73). In the closed position, the lid 805 may be secured to the base 810 and may limit the ingress of fluids into a volume of the cover 800. A snap-fit (or other similar connection) may selectively secure the lid 805 to the base 810 and limit the lid 805 from pivoting relative to the base.

In some forms, the base 810 may include a latch 835 that can selectively secure the lid 805 to the base 810. For example, the latch 835 may be a cantilever member formed on the base 810 that can selectively engage a ledge on the lid 805. The ledge may extend around at least a portion of the perimeter of the lid 805, or there may be multiple ledges, so that the latch 835 can engage the ledge in multiple orientations. When the lid 805 is latched (see e.g., FIGS. 68 and 71), the latch 835 engages the ledge (e.g., via a snap fit) and limits relative movement between the lid 805 and the base 810. In this position, a substantially waterproof seal may be formed between the lid 805 and the base 810 (e.g., by a gasket disposed between the lid 805 and the base 810). The illustrated base may include multiple latches 835 on opposite sides from the respective connecting regions 825, 830.

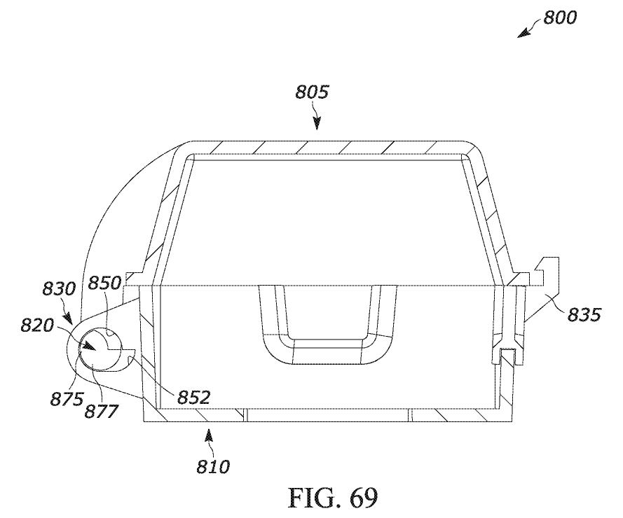

As shown in FIG. 69, the lid 805 may move to an unlatched position where the ledge of the lid 805 is disengaged from the latches 835. For example, the elongated shape of the opening 850 is larger than the size of the projection 870. In other words, the size of the opening 850 may permit the lid 805 to translate relative to the base 810. A user may translate the lid 805 so that an edge of the lid 805 moves away from the corresponding edge of the base 810. As the lid 805 translates, it moves beyond the end of the latches 835. Simultaneously, the projection 870 moves along the opening so that the protrusion 877 moves out of the slot 852. A user may continue to translate the lid 805 until the protrusion 877 has completely exited the slot 852. In this position, neither the latches 835 nor the protrusion 877 may limit the rotational movement of the lid 805. The lid 805 may still be considered in a closed position (despite not being latched to the base 810) because it still limits access to the internal volume 890.

As shown in FIG. 70, the lid 805 may pivot relative to the base 810 about the projections 870. For example, the lid 805 may pivot in a clockwise direction as viewed in FIG. 70 to expose the internal volume 890. The curved surface of the opening 850 may rotate along the curved surface of the projection 870. The translation between the lid 805 and the base 810 may create spacing between the slot 852 and the protrusion 877 so that the elements do not substantially interfere with the rotational movement of the lid 805.

In some forms, the lid 805 may be able to pivot at least 90 degrees relative to the closed position to provide full access to the internal volume 890. The lid 805 may be able to rest in the opened position (e.g., without assistance from user support), which may enable the user to interact with the electrical device within the internal volume 890 without needed to provide extra support to the lid 805 (e.g., the user may have both hands free).

In some forms, the user may pivot the lid 805 (e.g., counterclockwise as viewed in FIG. 70) so that it returns toward a closed position. Because the lid 805 initially moved away from the latches 835, the lid 805 may be able to pivot toward the closed position without contacting the latches 835. In this way, the lid 805 may be able to pivot entirely to the closed position (e.g., the unlatched position of FIG. 69) and would not get stuck on the latches 835 (e.g., which may occur when the lid 805 does not engage the latches 835 with enough force to cause the snap fit to engage). The user can then manually move the lid 805 from the unlatched position to the latched position to secure the lid 805 in the closed position.

As shown in FIGS. 71-73, the process to open and close the lid 805 may be substantially the same when the lid 805 is connected to the first connecting regions 815, 825 instead of the second connecting regions 820, 830 as illustrated in FIGS. 68-70. Accordingly, the description is not repeated for the sake of brevity.

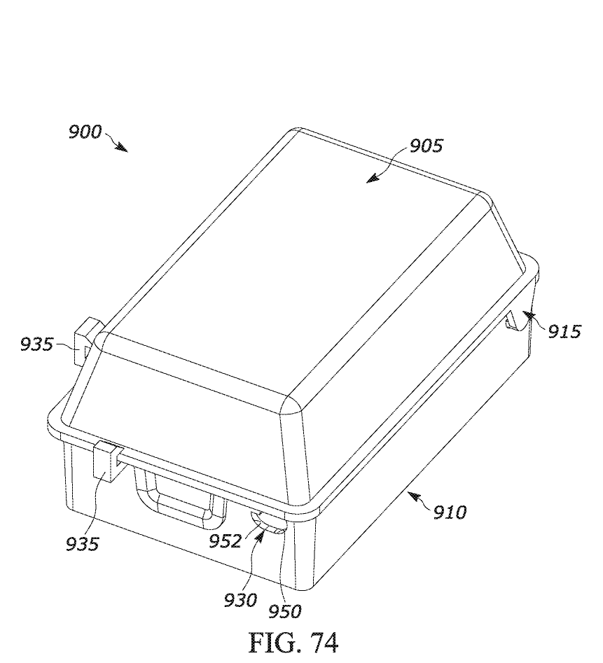

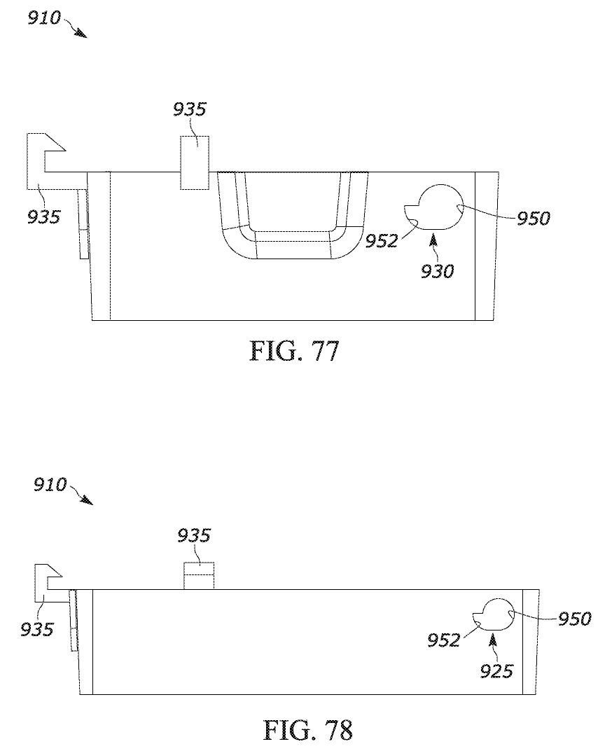

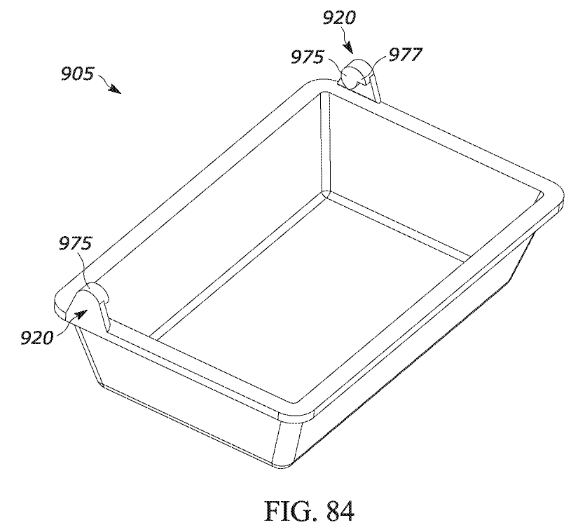

FIGS. 74-88 illustrate a nineth example of a cover 900. Only some similarities and differences between the cover 900 and the cover 100 may be described. The illustrated cover 900 may include a lid 905 and a base 910. The lid 905 may be movable relative to the base 910 and selectively securable to the base 910. For example, the lid 905 may be pivotable relative to the base 910, although other types of movement (e.g., translating) may be used.

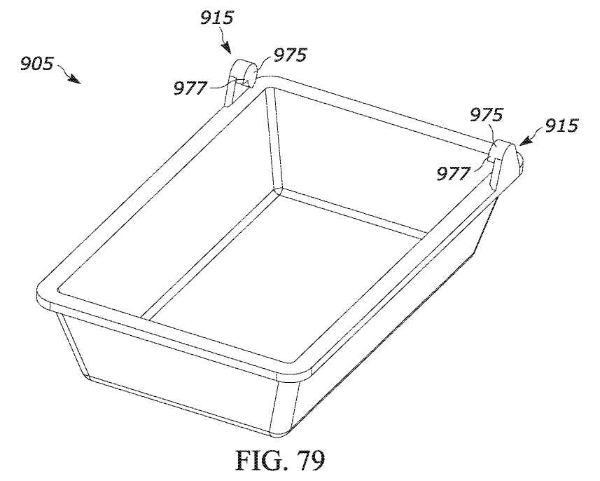

In some forms, the lid 905 may include a first connecting region 915. As shown in FIG. 79, the first connecting region 915 of the lid 905 may include projections 975. Each projection 975 may have an at least partially circular shape. For example, each projection 975 may have a substantially three-quarters circle shape. In other words, the projection 975 may have a semi-circular shape with a protrusion 977 (e.g., having a substantially quarter-circular shape) that has a similar size.

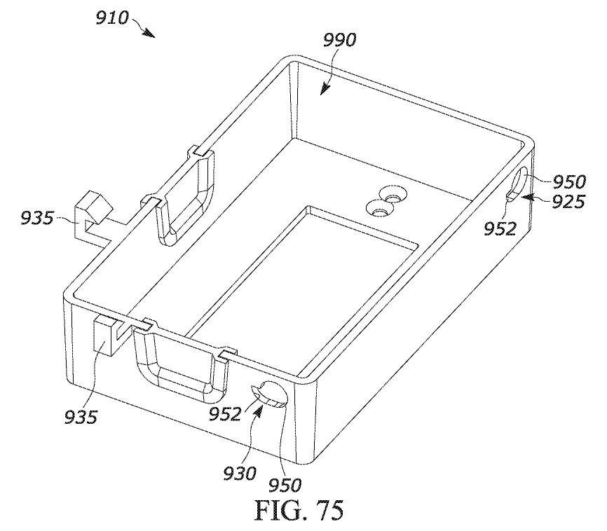

In some forms, the base 910 may include a first connecting region 925 and a second connecting region 930 disposed on a different edge of the base 910 than the first connecting region 925. As shown in FIGS. 75-78, the first connecting region 925 and the second connecting region 930 may be on perpendicular edges. In certain forms, the first and second connecting regions 925, 930 of the base 910 may be openings that can receive the projections 975 of the connecting regions 915 on the lid 905.

In some forms, each first and second connecting region 925, 930 of the base 910 may include an opening 950 may have an elongated shape. The illustrated opening 950 may extend only partially through a wall of the base 910. In other examples, one or more of the openings 950 may be disposed on the lid 905 and one or more of the projections 975 may be disposed on the base 910.

Each opening 950 may have a partially oval or pill shape. For example, one end of the opening 950 may be substantially semi-circular in shape. The opposite end of the opening 950 may have a substantially quarter circular shape, which forms a slot 952. A solid portion of the base 910 may be adjacent to the quarter-circular portion of the opening 950 (also in a substantially quarter circle shape) so that the ends of the opening 950 are not symmetrical.

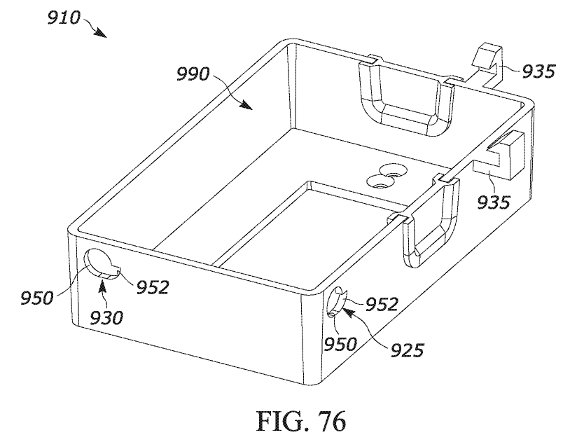

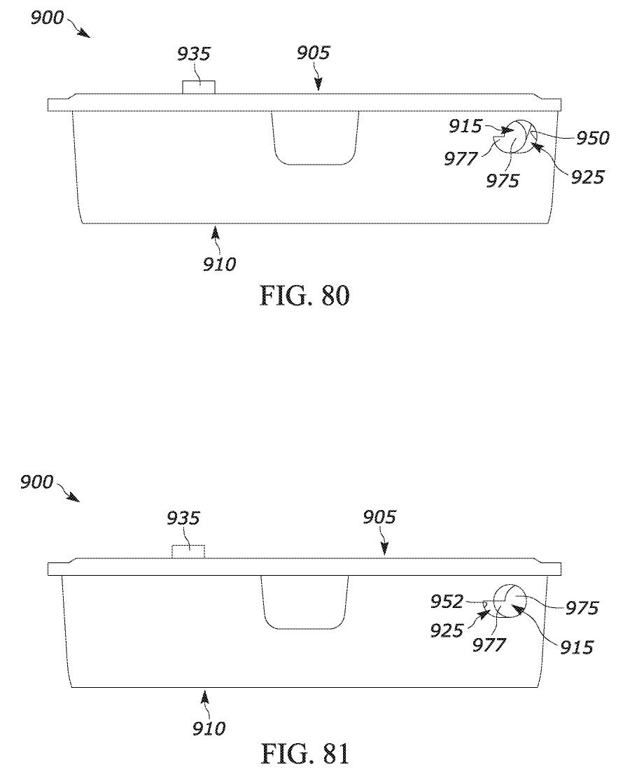

As shown in FIGS. 75 and 76, the base 910 may include an internal volume 990 that may be at least partially enclosed by the lid 905 (e.g., in the closed position of FIG. 80). The internal volume 990 may at least partially support an electrical device. In some examples, an extension ring may be coupled to the base 910 and provide an additional volume to house the electrical device. The extension ring may be removably coupled to the base 910 or may be integrally formed with the base 910.

The lid 905 may be connected to the base 910 by aligning the openings 950 with the projections 975. For example, when the first connecting region 915 of the lid 905 is positioned proximate to the corresponding connecting region 925 of the base 910, the shape of each projection 975 may align with the shape of the respective opening 950 so that the protrusion 977 is at least partially received within the slot 952.

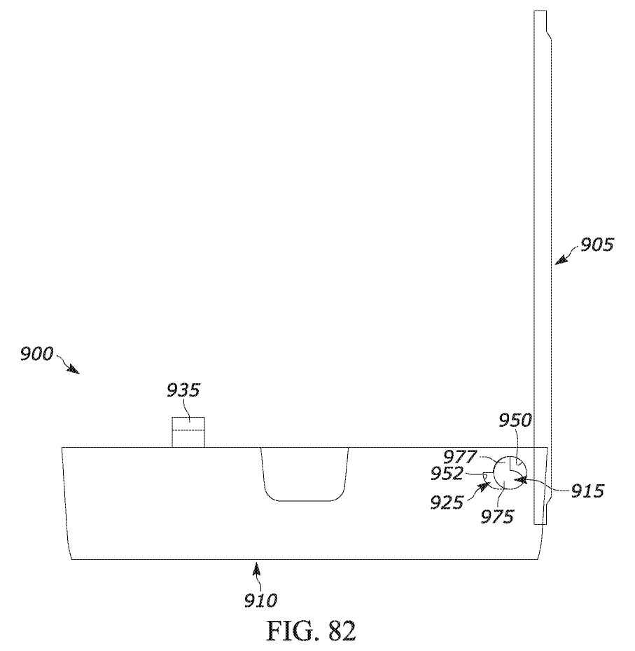

The lid 905 is selectively movable relative to the base 910 between a closed, latched position (see e.g., FIG. 80) and an open position (see e.g., FIG. 82). In the closed position, the lid 905 may be secured to the base 910 and may limit the ingress of fluids into a volume of the cover 900. A snap-fit (or other similar connection) may selectively secure the lid 905 to the base 910 and limit the lid 905 from pivoting relative to the base.

In some forms, the base 910 may include a latch 935 that can selectively secure the lid 905 to the base 910. For example, the latch 935 may be a cantilever member formed on the base 910 that can selectively engage a ledge on the lid 905. The ledge may extend around at least a portion of the perimeter of the lid 905, or there may be multiple ledges, so that the latch 935 can engage the ledge in multiple orientations. When the lid 905 is latched (see e.g., FIG. 74), the latch 935 engages the ledge (e.g., via a snap fit) and limits relative movement between the lid 905 and the base 910. In this position, a substantially waterproof seal may be formed between the lid 905 and the base 910 (e.g., by a gasket disposed between the lid 905 and the base 910). The illustrated base may include multiple latches 935 on opposite sides from the respective connecting regions 925, 930.

As shown in FIG. 81, the lid 905 may move to an unlatched position where the ledge of the lid 905 is disengaged from the latches 935. For example, the elongated shape of the opening 950 is larger than the size of the projection 970. In other words, the size of the opening 950 may permit the lid 905 to translate relative to the base 910. A user may translate the lid 905 so that an edge of the lid 905 moves away from the corresponding edge of the base 910. As the lid 905 translates, it moves beyond the end of the latches 935. Simultaneously, the projection 970 moves along the opening so that the protrusion 977 moves out of the slot 952. A user may continue to translate the lid 905 until the protrusion 977 has completely exited the slot 952. In this position, neither the latches 935 nor the protrusion 977 may limit the rotational movement of the lid 905. The lid 905 may still be considered in a closed position (despite not being latched to the base 910) because it still limits access to the internal volume 990.

As shown in FIG. 82, the lid 905 may pivot relative to the base 910 about the projections 970. For example, the lid 905 may pivot in a clockwise direction as viewed in FIG. 82 to expose the internal volume 990. The curved surface of the opening 950 may rotate along the curved surface of the projection 970. The translation between the lid 905 and the base 910 may create spacing between the slot 952 and the protrusion 977 so that the elements do not substantially interfere with the rotational movement of the lid 905.

In some forms, the lid 905 may be able to pivot at least 90 degrees relative to the closed position to provide full access to the internal volume 990. The lid 905 may be able to rest in the opened position (e.g., without assistance from user support), which may enable the user to interact with the electrical device within the internal volume 990 without needed to provide extra support to the lid 905 (e.g., the user may have both hands free).

In some forms, the user may pivot the lid 905 (e.g., counterclockwise as viewed in FIG. 82) so that it returns toward a closed position. Because the lid 905 initially moved away from the latches 935, the lid 905 may be able to pivot toward the closed position without contacting the latches 935. In this way, the lid 905 may be able to pivot entirely to the closed position (e.g., the unlatched position of FIG. 81) and would not get stuck on the latches 935 (e.g., which may occur when the lid 905 does not engage the latches 935 with enough force to cause the snap fit to engage). The user can then manually move the lid 905 from the unlatched position to the latched position to secure the lid 905 in the closed position.

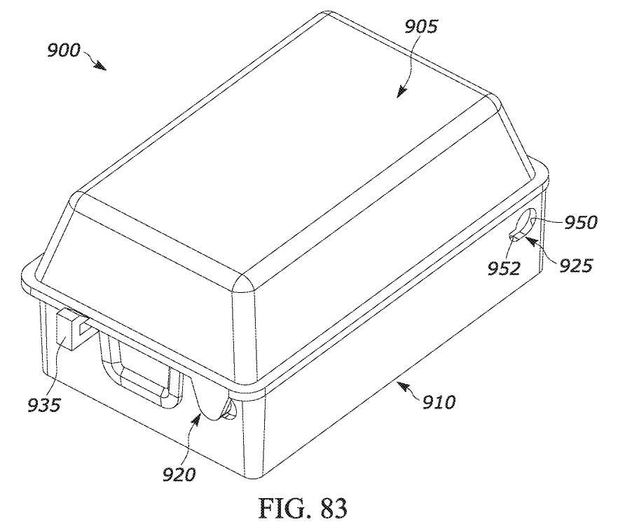

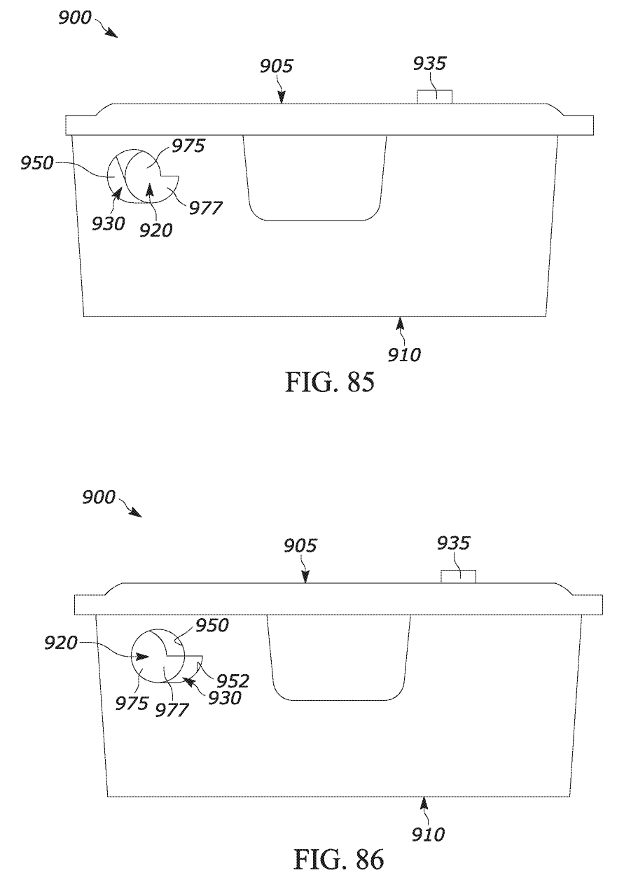

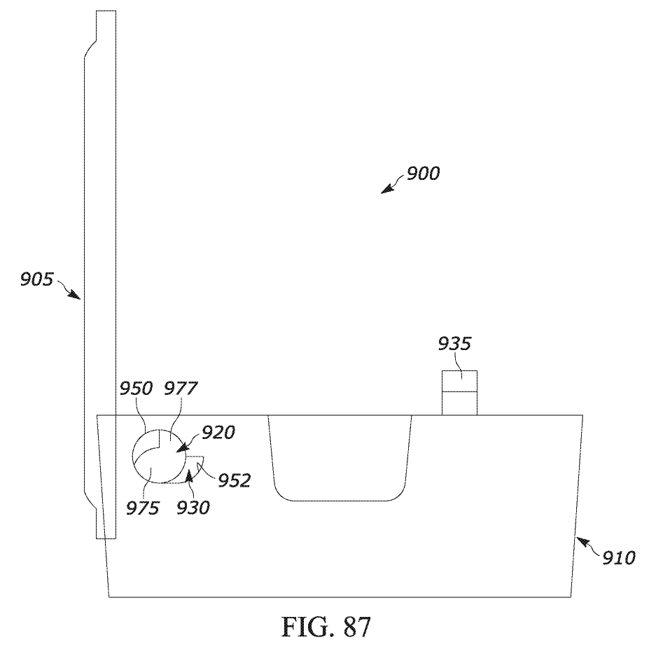

As shown in FIGS. 83-87, an alternate example of the lid 905 may be used with the cover 900. For example, the lid 905 may include a second connecting region 920 which may be substantially the same as the first connecting region 915 but may be disposed on adjacent (e.g., perpendicular) edges. The second connecting region 920 include a projection 975 may have a semi-circular shape with a protrusion 977 that is connectable to the second connecting region 930. The lid 905 is movable relative to the base 910 between a latched position (see e.g., FIG. 85), an unlatched position (see e.g., FIG. 86), and an opened position (see e.g., FIG. 87) in the same manner as the lid with the first connecting region 915.

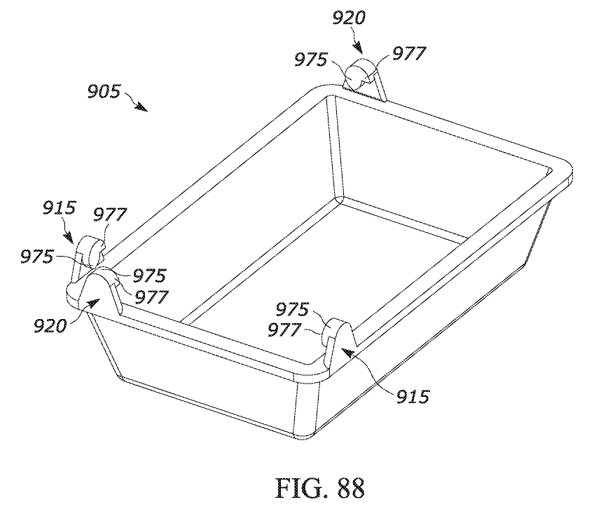

As shown in FIG. 88, a further alternate example of the lid 905 may be used with the cover 900. For example, the lid 905 may include a first connection region 915 and a second connecting region 920. This example of the lid 905 may be connected to either of the respective connecting regions 925, 930 on the base 910 (e.g., in a similar manner to the lid 805 described above). Once connected, the lid 905 may move between the latched, unlatched, and opened positions in the same way as previous described.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. An in-use cover for an electrical device, the cover comprising:
a base having an internal volume and including a projection having a first asymmetrical shape extending from an outer surface, wherein the first asymmetrical shape includes a first curved region and a first protruding region that extends from the first curved region; and
a lid pivotably connected to the base, the lid movable between an open position that at least partially exposes the electrical device and a closed position that is configured to enclose the electrical device in the internal volume, wherein the lid includes an opening having a second asymmetrical shape, wherein the second asymmetrical shape includes a second curved region and a second protruding region that extends from the second curved region;
wherein the projection is received within the opening; and
wherein the first protruding region is selectively positionable within the second protruding region to limit rotation of the lid relative to the base.

2. The cover of claim 1, wherein the base further includes a finger having an overhang, wherein the overhang is configured to engage the lid in a latched position, and wherein the lid is configured to translate relative to the base.

3. The cover of claim 2, wherein the lid is pivotable relative to the base by at least 90 degrees, and wherein the projection is configured to limit the lid from returning to the latched position.

4. The cover of claim 2, wherein the opening has an elongated shape with an opening length that is greater than a maximum length of the projection.

5. The cover of claim claim 1, wherein the first curved region has a semi-circular shape and a first protruding region has a quarter-circular shape.

6. An in-use cover for an electrical device, the cover comprising:
a base having an internal volume and including an opening having a first asymmetrical shape extending from an outer surface, wherein the first asymmetrical shape includes a first curved region and a first protruding region that extends from the first curved region; and
a lid pivotably connected to the base, the lid movable between an open position that at least partially exposes the electrical device and a closed position that is configured to enclose the electrical device in the internal volume, wherein the lid includes a projection having a second asymmetrical shape, wherein the second asymmetrical shape includes a second curved region and a second protruding region that extends from the second curved region;
wherein the projection is received within the opening; and
wherein the first protruding region is selectively positionable within the second protruding region to limit rotation of the lid relative to the base.

7. The cover of claim 6, wherein the base further includes a finger having an overhang, wherein the overhang is configured to engage the lid in a latched position, and wherein the lid is configured to translate relative to the base.

8. The cover of claim 7, wherein the lid is pivotable relative to the base by at least 90 degrees, and wherein the projection is configured to limit the lid from returning to the latched position.

9. The cover of claim 7, wherein the opening has an elongated shape with an opening length that is greater than a maximum length of the projection.

10. The cover of claim claim 6, wherein the first curved region has a semi-circular shape and a first protruding region has a quarter-circular shape.

11. An in-use cover for an electrical device, the cover comprising:
a base having an internal volume and including a projection having a first asymmetrical shape extending from an outer surface, wherein the first asymmetrical shape includes a first curved region and a first protruding region that extends from the first curved region; and
a lid connected to the base, wherein the lid includes an opening having a second asymmetrical shape, wherein the second asymmetrical shape includes a second curved region and a second protruding region that extends from the second curved region;
wherein the first protruding region is disposed within the second protruding region in a latched position to limit rotation of the lid relative to the base;
wherein the lid is translatable relative to the base between the latched position and an unlatched position, wherein the opening is configured to move relative to the projection so that the first protruding region is spaced apart from the second protruding region; and
wherein the lid is rotatable relative to the base between the unlatched position and an opened position where the internal volume is at least partially accessible.

12. The cover of claim 11, wherein the base further includes a finger having an overhang, wherein the overhang is configured to engage the lid in a latched position.

13. The cover of claim 12, wherein opening has an elongated shape with an opening length that is greater than a maximum length of the projection.

14. The cover of claim 12, wherein the overhang extends a first length and the opening is larger than the projection by a second length, and wherein the second length is at least as large as the first length to permit translation of the lid beyond an end of the overhang.

15. The cover of claim claim 11, wherein the first curved region has a semi-circular shape and a first protruding region has a quarter-circular shape.

16. The cover of claim claim 11, wherein the base further includes a third protruding region that extends from the first curved region, wherein the third protruding region has the same orientation as the first protruding region and is disposed 90 apart from the first protruding region.

17. The cover of claim 16, wherein the third protruding region is receivable within the second protruding region in the opened position, and wherein engagement between the second protrusion region and the third protruding region is configured to limit rotation of the lid relative to the base.

18. The cover of claim claim 11, wherein the base includes a first aperture and the lid includes a second aperture, wherein the first aperture is aligned with the second aperture, and wherein the first aperture and the second aperture are configured to receive a lock to secure the lid in the latched position.

19. The cover of claim claim 11, wherein the base includes a slot and the cover includes a pin received within the slot, and wherein the pin is configured to move through the slot as the lid moves relative to the base.

20. The cover of claim 19, wherein the pin has a first width and a second width greater than the first width, wherein the second width is greater than a width of the slot, and wherein the second width of the pin is disposed within the internal volume.

21-55. (canceled)
